(19) United States
(12) Patent Application Publication
(10) Pub. No.: US 2006/0144802 A1
(43) Pub. Date: Jul. 6, 2006

(54) Testing device and blood mixing and diluting method

(75) Inventors: Fumihisa Kitawaki, Toon-shi (JP); Toshihiko Yoshioka, Yokohama-shi (JP); Hirotaka Tanaka, Toon-shi (JP); Hirofumi Sugimoto, Saijo-shi (JP); Masanori Tanaka, Toon-shi (JP)

Correspondence Address: PEARNE & GORDON LLP, 1801 EAST 9TH SRTEET, SUITE 1200, CLEVELAND, OH, 44114-3108, US

(73) Assignee: Matsushita Electric Industrial Co., Ltd., Osaka (JP)

(21) Appl. No.: 11/317,618

(22) Filed: Dec. 23, 2005

(30) Foreign Application Priority Data
Dec. 28, 2004 (JP) 2004-380972
Apr. 6, 2005 (JP) 2005-109974

(51) Int. Cl. B01D 33/15; G01N 1/00; H01R 3/08; B01D 61/00

(52) U.S. Cl. 210/782; 436/174; 439/179; 210/767

(57) ABSTRACT

Herein discloses is a testing device, comprising therein an inlet port introducing a blood specimen thereinto, a blood separating chamber held in fluid communication with the inlet port through a fluid passageway to receive a blood specimen, and a hemolyzed blood chamber having accommodated therein a hemolyzed blood fluid. The testing device is operative to be rotated around a rotation center and stop from being rotated to have the blood specimen accommodated in the blood separating chamber into blood cells and a blood plasma fluid, and the blood separating chamber is held in fluid communication with the passageway merging area through a fluid passageway to have the blood plasma fluid separated from the blood specimen flowed through the fluid passageway, in such a manner that the hemolyzed blood fluid is mixed and diluted with the blood plasma fluid in the passageway merging area at a predetermined dilution ratio.

### TECHNICAL FIELD OF THE INVENTION

The present invention relates to a testing device for testing a blood specimen sample, and particularly to a testing device and a blood mixing and diluting method applicable in the field of clinical examination.

### DESCRIPTION OF THE RELATED ART

On account of progress in analysis, diagnosis, and testing technologies in recent years, measurements of various substances have now become possible. Especially in the field of clinical examination, measurement of substances contained in a body fluid reflecting disease conditions has become possible owing to development of measuring principles based on specific reactions such as biochemical reaction, enzymatic reaction, an immune reaction, and the like.

Among other things, ardent attention is paid to “Point of Care Testing”, hereinlater simply referred to as “POCT” in the field of clinical examination. The POCT is a pathological testing system frequently performed at the time of a consultation allowing the results to be used to make an immediate diagnosis about a patient. The primary purpose of the POCT is to achieve a simple and quick testing that reduces time taken after a specimen is collected until the testing result is obtained. Accordingly, the POCT requires a simple testing principle and a testing device which is small in size and excellent in portability and operability.

Device technology is remarkably progressed in recent years, and has now come to produce various small-sized testing devices which allow easy testing, as typified by a blood glucose sensor. The POCT is effective in that the POCT allows a prompt and accurate diagnosis by quickly obtaining the testing result, the testing costs are reduced, strain borne by a patient is alleviated, and the amount of infectious wastes is reduced owing to the reduction of the required amount of the specimen such, as for example, blood. Since the clinical examination is rapidly shifting to the POCT, the testing devices applicable to the POCT are under development to meet the demand.

As a target item to be tested using the POCT, “hemoglobin Alc”, hereinlater simply referred to as “HbAlc”, has attracted attention. HbAlc serves as a key guide of blood sugar control over a relatively long-term of, for example, one to three months for patients with diabetes.

A testing result for HbAlc is expressed by the percentage of the amount of a measured HbAlc to the amount of the total hemoglobins in a blood specimen. Accordingly, not only the amount of HbAlc but also the amount of the total hemoglobins is required to be measured. Unlike other target items to be tested in the blood specimen, HbAlc and all the other hemoglobins are contained in erythrocytes. This results in the fact that the erythrocytes of the blood specimen are required to be hemolyzed in order to measure an amount of HbAlc contained in the blood specimen. Here, the word “hemolyzing” or “hemolysis” is intended to mean phenomenon in which erythrocyte membranes are destroyed and hemoglobins are eluted out of erythrocytes. The size of each of erythrocytes is influenced by osmotic pressure exerted on each of erythrocyte membranes in extracellular fluid. Erythrocytes are dehydrated and shrunk in a salt solution whose salt concentration is higher than that of a normal saline solution (0.9% NaCl). On the other hand, erythrocytes are absorbing water and swollen in a salt solution whose salt concentration is lower than that of normal saline solution (0.9% NaCl). While the erythrocytes are shrunk and swollen, the erythrocyte membranes are destroyed and the hemoglobins are eluted out of the erythrocytes. Although there are individual differences, the amount of the total hemoglobins in blood is normally about 150 g/L. This is a very high concentration level, which is inconvenient in measuring hemoglobins.

Accordingly, in order to measure the amount of HbAlc, the blood specimen is required to be hemolyzed in advance, and then diluted with a buffer fluid at a predetermined range of concentration. This means that agents such as, for example, a hemolyzing agent, and the like are required and relevant operational steps are necessitated in addition to the analyzing steps, thereby making it complex and difficult to measure the amount of HbAlc.

In order to overcome the above inconveniences, there has been developed a testing device known as “Bayer DCA 2000 System” disclosed in Japanese Patent Laid-Open Publication H03-46566. The Bayer DCA 2000 System disclosed therein, hereinlater simply referred to as “conventional testing device”, is constituted by a reaction cassette rotatable around a substantially horizontal rotation axis, and comprising a reaction channel and inlet means in open liquid flow communication with the reaction channel for introducing a liquid specimen into the reaction channel. This means that the conventional testing device is provided with means for introducing thereinto a diluting fluid with ease. The reaction channel comprises a reagent zone having an analytical reagent accommodated therein, and means for disrupting the flow of the liquid specimen by gravity along the reaction channel sufficient to have the liquid specimen held in contact and mixed with the analytical reagent and agitated. The reaction cassette thus constructed is rotated and oscillated around the rotation axis to have the liquid specimen flowed through the reaction channel to be held in contact and mixed with the analytical reagent and agitated and to measure detectable reaction in the liquid specimen.

The conventional testing device such as “Bayer DCA 2000 System” cannot be applied to the POCT unless the conventional testing device is made further smaller in size and improved in portability. The conventional testing device thus constructed as previously mentioned, however, encounters a drawback in that the conventional testing device cannot be made small in size and improved in portability, resulting from the fact that the conventional testing device requires an agent such as, for example, a buffer fluid, and thus requires a space to have the agent accommodated therein. In order to dilute, for example, 1 μl, of a specimen at a dilution ratio of, for example, 500-fold, 500 μl of the buffer fluid is required. The conventional testing device cannot have a space for having accommodated therein 500 μl of the buffer fluid if the conventional testing device is made further smaller in size. This results in the fact that the specimen is required to be mixed and diluted with a buffer fluid in a place exterior to the conventional testing device, and then only a part of the diluted specimen is allowed to be introduced to the conventional testing device if the conventional testing device is made further smaller in size. The fact that the specimen is still required to be diluted at a high dilution ratio regardless of the limited capacity of the testing device leads to the fact that the conventional testing device cannot be made small in size and, thus weak in portability and operability. In addition, the remaining portion of the diluted specimen must be disposed of as waste.

Further, the conventional testing device encounters another drawback in that components forming part of plasma fluid of a blood specimen once tested cannot be used for other kinds of tests because of the fact that the blood specimen has been diluted with the diluting fluid, even though the conventional testing device may manage to have a space for having the diluting fluid accommodated therein.

The present invention is made with a view to overcoming the previously mentioned drawbacks inherent to the conventional testing device.

It is, therefore, an object of the present invention to provide a testing device which is small in size and excellent in portability and operability and requires a minimal amount of external fluid such as, for example, a buffer fluid, and the like to be introduced therein in comparison with the conventional testing device.

It is another object of the present invention to provide a testing device which produces a minimum waste fluid.

### DISCLOSURE OF THE INVENTION

In accordance with a first aspect of the present invention, there is provided a testing device, comprising therein: specimen inlet means for introducing a specimen sample; a plurality of chambers each held in fluid communication with an air opening; and a plurality of fluid passageways respectively extending from and held in fluid communication with the chambers, the fluid passageways including at least two fluid passageways in part merged with each other to collectively define a passageway merging area, and in which the at least two fluid passageways include one or more diluting fluid passageways having a diluting fluid flowed therethrough and a specimen fluid passageway held in fluid communication with the specimen inlet means to have the specimen sample flowed therethrough into the passageway merging area, in such a manner that the specimen sample is held in the passageway merging area to be mixed and diluted with the diluting fluid at a predetermined dilution ratio.

In the testing device according to the present invention thus constructed as previously mentioned, the one or more diluting fluid passageways each can have a diluting fluid flowed therethrough, ant the specimen fluid passageway can have the specimen sample flowed therethrough in such a manner that the specimen sample is mixed and diluted with the diluting fluid at a predetermined dilution ratio within the testing device, thereby making it possible for the testing device according to the present invention to be small in size and excellent in portability and operability and require a minimal amount of external fluid such as, for example, a buffer fluid, and the like to be introduced therein in comparison with the conventional testing device.

In the aforementioned testing device, the chambers may include a blood separating chamber held in fluid communication with the specimen inlet means through an inflow fluid passageway forming part of the specimen fluid passageway to receive a blood specimen, and a hemolyzed blood chamber having accommodated therein a hemolyzed blood fluid and held in fluid communication with the diluting fluid passageway. The testing device may be operative to be rotated around a rotation center and stop from being rotated to have the blood specimen accommodated in the blood separating chamber into blood cells and a blood plasma fluid, and the blood separating chamber may be held in fluid communication with the passageway merging area through an outflow fluid passageway forming part of the specimen fluid passageway to have the blood plasma fluid separated from the blood specimen flowed through the outflow fluid passageway, in such a manner that the hemolyzed blood fluid is mixed and diluted with the blood plasma fluid in the passageway merging area.

The testing device according to the present invention thus constructed as previously mentioned can separate the blood specimen into blood cells and a blood plasma within the blood separating chamber while the testing device is being rotated and dilute the hemolyzed blood fluid flowed from the hemolyzed blood chamber with the blood plasma thus obtained, thereby eliminating the need of any external fluid such as, for example, a buffer fluid, and the like, which is required for the preprocess in the conventional testing device.

In the aforementioned testing device, the passageway merging area may be formed with an air opening to have the blood plasma fluid and the hemolyzed blood fluid flowed thereinto and mixed with each other.

The testing device according to the present invention thus constructed as previously mentioned makes it easy for the blood plasma fluid and the hemolyzed blood fluid to be flowed and mixed with each other.

In the aforementioned testing device, the outflow fluid passageway of the specimen fluid passageway extending from the blood separating chamber to the passageway merging area may include an upper fluid passageway portion disposed inwardly of the blood separating chamber toward the rotation center and a lower fluid passageway portion disposed outwardly of the blood separating chamber from the rotation center.

The testing device according to the present invention thus constructed as previously mentioned makes it possible for the fluid contained in the blood separating chamber to be flowed through the fluid passageway in such a manner that a surface of the fluid contained in the blood separating chamber is equal in a distance from the rotation center of the testing device to a surface of the fluid contained in the fluid passageway while the testing device is being rotated, thereby enabling to have the fluid held in the blood separating chamber and the fluid passageway disposed outwardly of the surfaces of the blood separating chamber and the fluid passageway toward from the rotation center of the testing device while the testing device is being rotated.

In the aforementioned testing device, the blood separating chamber may have accommodated therein a hemolyzing agent for hemolyzing the blood specimen.

The testing device according to the present invention thus constructed as previously mentioned can hemolyze a blood specimen to obtain a hemolyzed blood fluid as well as separate a blood specimen into blood cells and a blood plasma therein. This leads to the fact that the testing device according to the present invention thus constructed can mix and dilute the hemolyzed blood fluid with the blood plasma fluid within the testing device only by introducing the blood specimen into the testing device.

In the aforementioned testing device, the blood separating chamber may have accommodated therein a denaturing agent for denaturing hemoglobins contained in hemolyzed blood.

In the testing device according to the present invention thus constructed as previously mentioned, after the hemolyzed blood fluid flowed into the blood separating chamber, for example, the binding of the hemoglobins contained in the hemolyzed blood fluid to blood glucose are promoted, thereby making it possible for the hemoglobins, especially HbAlc to be measured in accordance with an immunological reactivity principle.

In the aforementioned testing device, the blood separating chamber may have accommodated therein a proteolytic enzyme for breaking up hemoglobins contained in hemolyzed blood.

The testing device according to the present invention thus constructed as previously mentioned can break up each of the hemoglobins contained in the hemolyzed blood fluid into a plurality of peptide units, which can be readily reacted with antibodies without steric hindrance.

In the aforementioned testing device, the chambers may include two or more chambers held in fluid communication with one another through one or more of the fluid passageways each disposed inwardly of the chamber held in fluid communication with the specimen inlet means toward the rotation center, and one of the two or more chambers may be held in fluid communication with the specimen inlet means to have the blood specimen flowed from the specimen inlet means thereinto and then into the other remaining ones of the two or more chambers through the one or more of the fluid passageways.

The testing device according to the present invention thus constructed as previously mentioned makes it possible for a specimen sample introduced into the testing device through a single inlet port to be delivered from one chamber after another respectively by predetermined amounts whenever the chamber is filled with the specimen sample.

In accordance with a second aspect of the present invention, in the aforementioned testing device, the specimen inlet means may be operative to introduce therein a blood specimen, and the fluid passageways may include a hemolyzing process fluid passageway held in fluid communication with the specimen inlet means to have the blood specimen introduced from the specimen inlet means and hemolyzed therein.

The testing device according to the present invention thus constructed as previously mentioned can obtain a desired hemolyzed blood fluid from the blood specimen introduced into the testing device.

In the aforementioned testing device, the hemolyzing process fluid passageway may include: a hemolyzing process fluid passageway portion capable of having the blood specimen introduced from the specimen inlet means and temporarily held therein to have the blood specimen hemolyzed to produce a hemolyzed blood fluid, and fluid stopping means for stopping a fluid from being flowed into the hemolyzing process fluid passageway portion by a capillary action.

In the testing device according to the present invention thus constructed as previously mentioned, the fluid stopping means can prevent a fluid such as, for example, a blood from being flowed into the hemolyzing process fluid passageway by way of a capillary action at a predetermined position, in such a manner that the blood specimen can be hemolyzed to make a hemolyzed blood fluid in the hemolyzing process fluid passageway, and after the hemolyzing process is completed the hemolyzed blood fluid thus made can be flowed from the hemolyzing process fluid passageway in the manner other than the capillary valve action.

In the aforementioned testing device, the hemolyzing process fluid passageway portion may be merged with the other one or more fluid passageways to collectively define a passageway merging area to have the hemolyzed blood fluid flowed from the hemolyzing process fluid passageway portion into the passageway merging area.

The testing device according to the present invention thus constructed as previously mentioned ensures that the hemolyzed blood fluid is mixed with a fluid (for example, blood plasma fluid) flowed from the other fluid passageway with ease.

In the aforementioned testing device, the chambers may include a blood processing chamber intervening between and held in fluid communication with the specimen inlet means and the hemolyzing process fluid passageway, the hemolyzing process fluid passageway may further include: closing means disposed between the blood processing chamber and the hemolyzing process fluid passageway portion, for closing the hemolyzing process fluid passageway to have any fluid prevented from being flowed between the hemolyzing process fluid passageway portion and the blood processing chamber.

The testing device according to the present invention thus constructed as previously mentioned can prevent the hemolyzed blood fluid from being flowed from the hemolyzing process fluid passageway into the blood processing chamber and the fluid from being flowed from the blood processing chamber into the hemolyzing process fluid passageway portion, thereby stringently separating a blood processing process carried out in the blood processing chamber from the hemolyzing process carried out in the hemolyzing process fluid passageway.

In the aforementioned testing device, the hemolyzing process fluid passageway may further include fluid stopping means disposed between the hemolyzing process fluid passageway portion and the passageway merging area to stop a fluid from being flowed from the hemolyzing process fluid passageway portion into the passageway merging by a capillary action.

In the testing device according to the present invention thus constructed as previously mentioned, the fluid stopping means can prevent a hemolyzed blood fluid from being flowed into the passageway merging area at a predetermined position, thereby making it possible for the hemolyzed blood fluid to be further processed while being stopped from being flowed.

In the aforementioned testing device, the blood specimen may be hemolyzed while the testing device is being rotated, the hemolyzing process fluid passageway may further include an outflow fluid passageway portion extending from the hemolyzing process fluid passageway portion to the passageway merging area, and the outflow fluid passageway portion may include an upper outflow fluid passageway portion disposed inwardly of the blood processing chamber toward the rotation center and a lower outflow fluid passageway portion disposed outwardly of the blood processing chamber from the rotation center.

In the testing device according to the present invention thus constructed as previously mentioned, makes it possible for the hemolyzed blood fluid to be held in a predetermined area of the blood processing chamber and the lower outflow fluid passageway while the testing device is being rotated.

In the aforementioned testing device, the closing means may be operative to cause a chemical change between the blood processing chamber and the hemolyzing process fluid passageway portion to close the hemolyzing process fluid passageway to have any fluid prevented from being flowed between the hemolyzing process fluid passageway portion and the blood processing chamber.

In the testing device according to the present invention thus constructed as previously mentioned makes it easy to close the hemolyzing process fluid passageway by way of, for example, blood coagulation.

In accordance with a third aspect of the present invention, in the aforementioned testing device, the one or more diluting fluid passageways may have the diluting fluid flowed through the passageway merging area toward a predetermined direction, and the specimen fluid passageway may be capable of having the specimen sample temporarily held in the passageway merging area, to have the specimen sample mixed and diluted with the diluting fluid at a predetermined ratio. The testing device according to the present invention thus constructed as previously mentioned ensures that the specimen sample held in the passageway merging area is mixed and diluted with the diluting fluid being flowed through the passageway merging area at the predetermined direction.

In the aforementioned testing device, the specimen fluid passageway and each of the one or more diluting fluid passageways may be intersected by and held in fluid communication with each other at the passageway merging area through a space greater in width than the other neighboring portion of each of the specimen fluid passageway and the one or more diluting fluid passageways. The testing device according to the present invention thus constructed as previously mentioned can prevent the specimen fluid passageway and each of the one or more diluting fluid passageways from being interfered with each other.

In the aforementioned testing device, each of the specimen fluid passageway and the one or more diluting fluid passageways may have an end portion held in fluid communication with an air opening. The testing device according to the present invention thus constructed as previously mentioned makes it easy for the specimen sample and the diluting fluid to be flowed.

In the aforementioned testing device, the plurality of fluid passageways may include an extension fluid passageway having an end portion held in fluid communication with the specimen fluid passageway at the passageway merging area through a space greater in width than the other neighboring portion of the specimen fluid passageway and the extension fluid passageway. The testing device according to the present invention thus constructed as previously mentioned can prevent the specimen fluid passageway and the extension fluid passageway from being interfered with each other while the testing device is stopped from being rotated as well as makes it possible for the specimen sample to be mixed and diluted with the diluting fluid at the passageway merging area, and later to be flowed through the extension fluid passageway while the testing device is being rotated.

In the aforementioned testing device, the fluid passageways may include a fluid passageway having a turnup portion disposed outwardly of the passageway merging area from the rotation center to have the fluid specimen accommodated therein in the turnup portion. The testing device according to the present invention thus constructed as previously mentioned makes it possible for a fluid to be held in the turnup portion while the testing device is being rotated.

In accordance with a fourth aspect of the present invention, there is provided a blood mixing and diluting method, comprising: an introducing step of introducing a blood specimen into a testing device; a dividing step of dividing the blood specimen introduced into the testing device in the introducing step into a first blood portion to be hemolyzed and a second blood portion to be separated into a blood plasma and blood cells; a blood cell and blood plasma obtaining step of rotating the testing device to have the first blood portion hemolyzed and the second blood portion separated into blood cells and a blood plasma; a fluid flowing step of stopping the testing device from rotating to have a fluid of the hemolyzed blood, i.e., and a hemolyzed blood fluid and the blood plasma flowed through respective fluid passageways; and a mixing and diluting step of rotating the testing device to have the hemolyzed blood fluid mixed and diluted with the blood plasma.

In accordance with the blood mixing and diluting method according to the present invention as previously mentioned, the specimen sample introduced into the testing device is divided into a first blood portion to be hemolyzed and a second blood portion to be separated into a blood plasma and blood cells, the first blood portion is then hemolyzed and the second blood portion is separated into blood cells and a blood plasma while the testing device is being rotated, the hemolyzed blood fluid and the blood plasma fluid are flowed through respective fluid passageways when the testing device is stopped from being rotated, and the hemolyzed blood fluid is mixed and diluted with the blood plasma fluid when the testing device is again rotated. This leads to the fact that the blood mixing and diluting method according to the present invention as previously mentioned can divide a blood specimen into a first blood portion and a second blood portion, hemolyze the first blood portion and separate the second blood portion into blood cells and a blood plasma, and mix and dilute the hemolyzed blood fluid with the blood plasma only by controlling the testing device to be rotated or stopped from being rotated.

In accordance with a fifth aspect of the present invention, in the aforementioned testing device, the chambers may include a blood separating chamber held in fluid communication with the specimen inlet means to receive a blood specimen to have therein the blood specimen hemolyzed and separated into a blood plasma and blood cells while the testing device is rotated, a diluting fluid introducing chamber for introducing thereinto a diluting fluid for diluting components forming part of the blood specimen, and a mixing chamber for receiving the blood plasma and the diluting fluid to have the blood plasma mixed with and diluted with the diluting fluid while the testing device is rotated, and the blood separating chamber may have accommodated therein a hemolyzing agent for hemolyzing components forming part of the blood specimen. The testing device according to the present invention thus constructed as previously mentioned can carry out a preprocess, viz., a blood separating process, a blood hemolyzing process, and a diluting process only by introducing a blood specimen and a diluting fluid into the testing device and controlling the testing device to be rotated and stopped from being rotated, thereby making it possible for the testing device according to the present invention to be small in size and excellent in portability and operability and require a minimal amount of external fluid such as, for example, a buffer fluid, and the like to be introduced therein in comparison with the conventional testing device.

In the aforementioned testing device, a total capacity of the testing device may be capable of having introduced therein equal to or greater than an amount of the diluting fluid required to dilute all of the components forming part of the blood specimen. The testing device according to the present invention thus constructed as previously mentioned can prevent the diluting fluid from overflowing therefrom.

In the aforementioned testing device, an amount of the hemolyzing agent accommodated in the blood separating chamber may fall short of hemolyzing all of the blood specimen accommodated in the blood separating chamber. The testing device according to the present invention thus constructed as previously mentioned can partially hemolyze the blood specimen accommodated in the blood separating chamber, and thus lessen an amount of hemolyzed blood fluid to be made, thereby reducing the amount of the diluting fluid required to be introduced therein.

In the aforementioned testing device, an amount of the hemolyzing agent accommodated in the blood separating chamber may be substantially small enough to have the components forming part of the blood plasma partially hemolyzed to such an extent that the components forming part of the blood plasma partially hemolyzed are mixed and diluted with the diluting fluid in the mixing chamber at a dilution ratio of 250 or greater. The testing device according to the present invention thus constructed as previously mentioned can partially hemolyze the blood specimen accommodated in the blood separating chamber and thus lessen an amount of hemolyzed blood fluid to be made, to the degree that components forming part of the blood plasma thus hemolyzed can be mixed and diluted with the diluting fluid in the mixing chamber at a high dilution ratio of 250 or greater, thereby making it possible for the fluid thus obtained to be quantified directly by a calorimetric method. For example, Hb concentration can be measured by a calorimetric analysis using a SLS-Hb method. In the case of HbAlc, measurement can be carried out based on boronic acid affinity principle, enzyme reaction principle, or the like.

In the aforementioned testing device, an amount of the hemolyzing agent accommodated in the blood separating chamber may be substantially small enough to have the components forming part of the blood plasma partially hemolyzed to such an extent that the components forming part of the blood plasma partially hemolyzed are mixed and diluted with the diluting fluid in the mixing chamber at a dilution ratio of 500 or greater. The testing device according to the present invention thus constructed as previously mentioned makes it possible for the fluid thus obtained to be quantified directly by a competitive immunoassay method. In the case of measuring, for example, HbAlc, the components forming part of the blood plasma partially hemolyzed are required to be diluted at a dilution ratio ranging between approximately 500 to 5000 depending upon performance of antibody.

In the aforementioned testing device, an amount of the hemolyzing agent accommodated in the blood separating chamber may be substantially small enough to have the components forming part of the blood plasma partially hemolyzed to such an extent that the components forming part of the blood plasma partially hemolyzed are mixed and diluted with the diluting fluid in the mixing chamber at a dilution ratio of 5000 or greater. The testing device according to the present invention thus constructed as previously mentioned makes it possible for the fluid thus obtained to be quantified directly by an immunoassay method.

In the aforementioned testing device, the chambers may further include: a blood plasma fluid sampling chamber for taking thereinto a predetermined amount of a blood plasma fluid flowed from the blood separating chamber to be mixed with the diluting fluid in the mixing chamber. The testing device according to the present invention thus constructed as previously mentioned can carry out a preprocess of measuring hemoglobins only while the testing device is controlled to be rotated and stopped from being rotated.

The aforementioned testing device may further comprise a denaturing agent for denaturing proteins forming part of the blood plasma fluid in a predetermined area to have the denaturing agent reacted with the predetermined amount of the blood plasma fluid taken into the blood plasma fluid sampling chamber. The testing device according to the present invention thus constructed as previously mentioned makes it possible for hemoglobins contained in the blood plasma fluid to be immunologically measured. Especially, in the case of measuring HbAlc in accordance with an immunological reactivity principle, proteins contained in the blood plasma fluid are required to be denatured so that beta-chain amino acid area of each of the proteins is exposed. The denaturing agent may be freeze-dried and accommodated in, for example, an area where the hemolyzed blood plasma fluid is introduced. Here, as the denaturing agent may be used, for example, a salt including chaotropic ion, a surface acting agent, an oxidizing agent, or the like.

The aforementioned testing device may further comprise a proteolytic enzyme for breaking up proteins forming part of the blood plasma fluid in a predetermined area to have the proteolytic enzyme reacted with the predetermined amount of the blood plasma fluid taken into the blood plasma fluid sampling chamber. The testing device according to the present invention thus constructed as previously mentioned makes it possible for hemoglobins contained in the blood plasma fluid to be immunologically measured. Especially, in the case of measuring HbAlc in accordance with an immunological reactivity principle, proteins contained in the blood plasma fluid are required to be broken up in order that beta-chain terminal amino acid fragments of HbAlc are made.

In the aforementioned testing device, at least one of the chambers and the fluid passageways may be held in fluid communication with an air opening. The testing device according to the present invention thus constructed as previously mentioned makes it easy for a fluid to be flowed. When the air opening is provided in a fluid passageway or a chamber, air in the fluid passageway or the chamber can come out and the fluid easily flow through the fluid passageway or the chamber. This means that air must be flowed in order to have the fluid flowed smoothly through the fluid passageway or the chamber. This leads the fact that the air opening is essential for the fluid flowing through the fluid passageway or the chamber. Further, while the testing device is being rotated around a rotation center, the fluid may leak through the air opening. It is therefore preferable that the air opening is provided in the fluid passageway or the chamber at a point, for example, closest to the rotation center.

In the aforementioned testing device at least one of the fluid passageways may have a turnup portion disposed inwardly of a chamber, which the at least one of the fluid passageways is held in communication with, toward the rotation center to have a fluid flowed therethrough by way of a capillary action. The testing device according to the present invention thus constructed as previously mentioned can have the fluid held in the chamber by a centrifugal force while the testing device is being rotated and have the fluid flowed through the at least one of the fluid passageways by way of a capillary action after the testing device is stopped from being rotated and the fluid is released from the centrifugal force.

In the aforementioned testing device, the chambers may include one or more hemolyzed blood chambers each having accommodated therein the hemolyzing agent, an amount of the hemolyzing agent accommodated in each of the one or more hemolyzed blood chambers falls short of hemolyzing the entire blood specimen accommodated in the one or more hemolyzed blood chambers. The testing device according to the present invention thus constructed as previously mentioned can further partially hemolyze the blood specimen accommodated in the one or more hemolyzed blood chambers in addition to the blood separating chamber for one or more additional times, and thus further lessen an amount of hemolyzed blood fluid to be made, thereby further reducing the amount of the diluting fluid required to be introduced therein.

In accordance with a sixth aspect of the present invention, there is provided a blood mixing and diluting method of mixing and diluting components forming part of a blood specimen using a testing device, comprising: an introducing step of introducing a blood specimen into the testing device; a diluting fluid introducing step of introducing a diluting fluid for diluting the components forming part of the blood specimen; a hemolyzing and separating step of rotating the testing device to have the blood specimen hemolyzed and separated into blood cells and a blood plasma; a fluid flowing step of stopping the testing device from rotating to have a fluid from the blood plasma and the diluting fluid flowed; and a mixing and diluting step of rotating the testing device to have the fluid from the blood plasma mixed with the diluting fluid. The blood mixing and diluting method according to the present invention as previously mentioned can carry out a preprocess of measuring hemoglobins only while the testing device is controlled to be rotated and stopped from being rotated, thereby making it possible for the testing device according to the present invention to be small in size and excellent in portability and operability and require a minimal amount of external fluid such as, for example, a buffer fluid, and the like to be introduced therein in comparison with the conventional testing device.

### BRIEF DESCRIPTION OF THE DRAWINGS

The features and advantages of a testing device and a blood mixing and diluting method according to the present invention will be more clearly understood from the following description taken in conjunction with the accompanying drawings in which:

FIG. 1(a) is a block diagram showing a first passageway part forming part of a first example of a testing device according to the present invention;

FIG. 1(b) is a block diagram showing a second passageway part forming part of the first example of the testing device according to the present invention;

FIG. 2(a) is a cross sectional view for explaining how the first passageway part shown in FIG. 1(a) is produced;

FIG. 2(b) is a cross sectional view taken along the line II-II of FIG. 1(a);

FIG. 3(a) is a cross sectional view for explaining how the second passageway part shown in FIG. 1(b) is produced;

FIG. 3(b) is a cross sectional view taken along the line III-III of FIG. 1(b);

FIG. 4 is a schematic view showing a second example of the testing device according to the present invention;

FIG. 5 is a schematic top view of the second example of the testing device according to the present invention;

FIG. 6 is a schematic view showing a rotating device for rotating the testing device according to the present invention;

FIG. 7 is a schematic view showing a third example of the testing device according to the present invention;

FIG. 8 is a schematic view showing a fourth example of the testing device according to the present invention;

FIG. 9 is a schematic view showing a fifth example of the testing device according to the present invention;

FIG. 10 is a schematic view showing a sixth example of the testing device according to the present invention;

FIG. 11 is a graph showing an analytical curve made in accordance with SLS-HB principle;

FIG. 12 is a graph showing an analytical curve made in accordance with latex immune agglutination principle;

FIG. 13 is a schematic elevational view of a seventh example of a testing device according to the present invention; and

FIG. 14 is a schematic elevational view of an eighth example of a testing device according to the present invention.

### DESCRIPTION OF THE PREFERRED EMBODIMENTS

A preferred embodiment of the present invention will be described hereinafter with reference to the drawings.

Each of testing devices described hereinlater has formed therein a functional passageway such as, for example, a capillary tube and is rotatable around a rotation axis while testing a specimen, regardless of whether the rotation axis may pass through the testing device or extend exterior to the testing device. This means that the testing devices according to the present invention include a self-rotation type testing device having the rotation axis passing therethrough and a rotatable type testing device having the rotation axis exterior thereto and rotatable along a circumference having a predetermined radius. Further, it is to be noted that the number of rotations and time appearing herein and constituting rotation control parameters used to control fluids flowed in the testing device are shown by way of examples and does not limit the present invention.

### First Preferred Embodiment

The first preferred embodiment of the testing device according to the present invention will be described hereinlater.

The present embodiment of the testing device is in the form of a cassette shape, and comprises a specimen inlet means for introducing a specimen sample thereinto; a plurality of chambers each held in fluid communication with an air opening; and a plurality of fluid passageways respectively extending from and held in fluid communication with the chambers, the fluid passageways including at least two fluid passageways in part merged with each other to collectively define a passageway merging area. The at least two fluid passageways include one or more diluting fluid passageways having a diluting fluid flowed therethrough and a specimen fluid passageway held in fluid communication with the specimen inlet means to have the specimen sample flowed therethrough into the passageway merging area, in such a manner that the specimen sample is held in the passageway merging area to be mixed and diluted with the diluting fluid at a predetermined dilution ratio. The size of each of the chambers and the passageway merging area is determined based on the target dilution ratio.

In the present embodiment, it is assumed that the testing device comprises, for example, two chambers constituted by a blood separating chamber held in fluid communication with the specimen inlet through an inflow fluid passageway forming part of the specimen fluid passageway to receive a blood specimen, and a hemolyzed blood chamber having accommodated therein a hemolyzed blood fluid and held in fluid communication with a fluid passageway. The testing device is operative to be rotated around a rotation center and stop from being rotated to have the blood specimen accommodated in the blood separating chamber into blood cells and a blood plasma fluid. The blood separating chamber is held in fluid communication with the passageway merging area through an outflow fluid passageway forming part of the specimen fluid passageway to have the blood plasma fluid separated from the blood specimen flowed through the outflow fluid passageway, in such a manner that the hemolyzed blood fluid is mixed and diluted with the blood plasma fluid in the passageway merging area. Here, it is assumed that the hemolyzed blood fluid accommodated in the hemolyzed blood chamber is in advance prepared by hemolyzing the blood specimen. The ratio in size of the chambers, viz., the blood separating chamber and the hemolyzed blood chamber is determined in accordance with the target dilution ratio.

In the present embodiment, each of the fluid passageways has a width small enough to have a fluid flowed therethrough by a capillary action. Air opening is essential for the fluid flowing through the fluid passageway or the chamber. When the air opening is provided in the fluid passageway or the chamber, air in the fluid passageway or the chamber can come out and the fluid easily flow through the fluid passageway or the chamber. The chamber or the fluid passageway is required to be formed with and held in fluid communication with an air opening to ensure that a fluid is smoothly flowed therethrough. Further, while the testing device is being rotated around a rotation center, the fluid may leak through the air opening. It is therefore preferable that the air opening is provided in the fluid passageway or the chamber at a point, for example, closest to the rotation center. The testing device may include an overflow chamber for having accommodated therein a fluid such as, for example, a blood specimen, a hemolyzed blood fluid, or the like overflowed from the other chamber. A chamber (flowing-in chamber), which the fluid is flowed into, may be made relatively large in size so as to prevent the fluid from leaking therefrom.

In the present embodiment, the fluid is mixed and diluted in the passageway merging area where a plurality of, for example, two fluid passageways are intersected and in part merged with each other. The passageway merging area may be constituted by a chamber or another single fluid passageway.

Air opening is essential for the fluid flowing through the passageway merging area. As soon as air is blocked at the passageway merging area by fluids respectively flowing through the fluid passageways, the fluids come to a stationary state, and the testing device cannot operate properly. In the present embodiment, the passageway merging area is formed with and held in fluid communication with an air opening to ensure that the blood plasma and the hemolyzed blood fluid are easily flowed thereinto.

In the present embodiment, a fluid passageway extending between and held in fluid communication with the chamber and the passageway merging area includes an upper fluid passageway portion disposed inwardly of an upper surface of the chamber (closest to the rotation center) toward the rotation center of the testing device and a lower fluid passageway portion disposed outwardly of an outlet port of the chamber (which the fluid is flowed from) toward the rotation center of the testing device. Here, the word “upper” or “upper direction” is intended to mean a direction to which a centrifugal force is exerted against while the testing device is being rotated, and the word “lower” or “lower direction” is intended to mean the direction to which the centrifugal force is exerted for while the testing device is being rotated. It is preferable that the upper fluid passageway portion is in the form of, for example, an inverted U shape having a turnup portion disposed inwardly of the upper surface of the chamber toward the rotation center of the testing device. The fluid passageway thus constructed can have the fluid held in the chamber and the lower fluid passageway portion by a centrifugal force while the testing device is being rotated, and have the fluid further flowed through the upper fluid passageway portion by a capillary action when the testing device is stopped from being rotated and the fluid is released from the centrifugal force. On the contrary, the turnup portion may be disposed equal to or outwardly of the upper surface of the chamber from the rotation center if the fluid is required to be flowed incessantly.

The fluid passageway has formed with a space greater in width than neighboring portions of the fluid passageway, hereinlater simply referred to as “capillary valve” at an appropriate position.

The operation of the present embodiment of the testing device will be described hereinlater.

A blood specimen is introduced into the blood separating chamber and, a hemolyzed blood fluid is introduced into a introduced into a hemolyzed blood chamber. The hemolyzed blood fluid is in advance prepared by hemolyzing the blood specimen. The blood specimen introduced into the blood separating chamber is flowed through a first fluid passageway by a capillary action up to a capillary valve formed in the first fluid passageway. Likewise, the hemolyzed blood flood introduced into the hemolyzed blood chamber is flowed through a second fluid passageway by a capillary action up to a capillary valve formed in the second fluid passageway.

The testing device is then rotated at a predetermined rotation speed. While the testing device is being rotated, the blood specimen is separated into blood cells and a blood plasma, and a fluid thus separated in the blood separating chamber is further flowed through the first fluid passageway beyond the capillary valve by a centrifugal force to such an extent that a surface of the fluid contained in the blood separating chamber is approximately equal in a distance from the rotation center of the testing device to a surface of the fluid contained in the first fluid passageway (prior to the upper fluid passageway portion of the first fluid passageway). The fluid thus flowed through the first fluid passageway beyond the capillary valve is a blood plasma fluid separated from the blood specimen. Likewise, while the testing device is being rotated, the hemolyzed blood fluid contained in the hemolyzed blood chamber is further flowed through the second fluid passageway beyond the capillary valve by a centrifugal force to such an extent that a surface of the fluid contained in the hemolyzed blood chamber is approximately equal in a distance from the rotation center of the testing device to a surface of the fluid contained in the second passageway fluid (prior to the upper fluid passageway portion of the second fluid passageway). The hemolyzed blood fluid thus flowed through the second fluid passageway beyond the capillary valve is separated from impurities such as, for example, blood cell residues.

The testing device is stopped from being rotated. The blood plasma fluid is further flowed through the first fluid passageway by a capillary action and stopped short of the passageway merging area. The first fluid passageway may be formed with a capillary valve at a point prior to the passageway merging area. Likewise, when the testing device is stopped from being rotated, the hemolyzed blood fluid is further flowed through the second fluid passageway by a capillary action and stopped short of the passageway merging area. The second fluid passageway may be formed with a capillary valve at a point prior to the passageway merging area.

The testing device is again rotated at a predetermined rotation speed to have the hemolyzed blood fluid mixed and diluted with the blood plasma fluid at a predetermined dilution ratio. As described hereinearlier, the dilution ratio is determined in accordance with the ratio in size of the chambers, viz., the blood separating chamber and the hemolyzed blood chamber.

In the present embodiment, the rotation speed of the testing device may be any value as long as it is ensured that the blood specimen is sufficiently separated into blood cells and a blood plasma, and the fluids are sufficiently flowed through the fluid passageways.

The blood separating chamber may have accommodated therein a hemolyzing agent for hemolyzing the blood specimen. The testing device thus constructed can carry out a hemolyzing process of hemolyzing the blood specimen as well as separate the blood specimen into blood cells and a blood plasma while the testing device is being rotated.

Further, the blood separating chamber may have accommodated therein a denaturing agent for denaturing hemoglobins contained in a hemolyzed blood plasma fluid. The blood separating chamber may have accommodated therein a proteolytic enzyme for breaking up hemoglobins contained in a hemolyzed blood plasma fluid. The testing device thus constructed makes it possible for hemoglobins, especially, HbAlc, contained in the blood plasma fluid to be measured based on antigen-antibody complex reaction.

According to the present invention, as the hemolyzing agent and the denaturing agent may be used, for example, salts, a surface acting agent, and the like. The hemolyzing agent and the denaturing agent serve to destroy the erythrocyte membranes while osmotic pressure exerted on each of erythrocyte membranes is changed. As the proteolytic enzyme may be used, for example, pepsin, trypsin, lysyl endopeptidase, endoproteinase, arginine endopeptidase, and the like.

In the device according to the present invention, two or more chambers may be held in fluid communication with one another through one or more of the fluid passageways each disposed inwardly of the chamber held in fluid communication with the specimen inlet means toward the rotation center, and one of the two or more chambers may be held in fluid communication with the specimen inlet means to have the blood specimen flowed from the specimen inlet means thereinto and then into the other remaining ones of the two or more chambers through the one or more of the fluid passageways. The testing device thus constructed makes it possible for a specimen sample introduced into the testing device through a single inlet port to be delivered from one chamber after another respectively by predetermined amounts whenever the chamber is filled with the specimen sample. This means that the testing device thus constructed can deliver the specimen sample to a plurality of chambers including the blood separating chamber and the hemolyzed blood chamber, by introducing the specimen sample into the inlet port only once. If the hemolyzed blood chamber has accommodated therein the aforementioned hemolyzing agent, the hemolyzing process of hemolyzing the blood specimen can be carried out as soon as the blood specimen is introduced into the inlet port. When the testing device is rotated, the hemolyzed blood fluid can be obtained.

### Second Preferred Embodiment

The second preferred embodiment of the testing device according to the present invention will be described hereinlater.

In the second embodiment of the testing device, the specimen inlet means is operative to introduce therein a blood specimen, and the fluid passageways includes a hemolyzing process fluid passageway held in fluid communication with the specimen inlet means to have the blood specimen introduced from the specimen inlet means and hemolyzed therein.

The present embodiment of the testing device thus constructed as previously mentioned can obtain a desired hemolyzed blood fluid from a blood specimen by introducing the blood specimen into the specimen inlet means only once. This means that the blood specimen introduced into the specimen inlet means is divided into a first blood portion to be hemolyzed and a second blood portion to be separated into a blood plasma and blood cells, resulting from the fact that the blood specimen is in part flowed through the hemolyzing process fluid passageway and in part flowed into the blood processing chamber.

The hemolyzing process of hemolyzing the blood specimen takes a predetermined time period. It is preferable that the hemolyzing process fluid passageway includes a hemolyzing process fluid passageway portion capable of having the blood specimen introduced from the specimen inlet means and temporarily held therein to have the blood specimen hemolyzed to produce a hemolyzed blood fluid. In the present embodiment, the hemolyzing process fluid passageway comprises fluid stopping means constituted by a capillary valve for stopping a fluid from being flowed into the hemolyzing process fluid passageway portion by a capillary action. The hemolyzed blood fluid thus made in the hemolyzing process fluid passageway and the blood plasma fluid separated from the blood specimen in the blood processing chamber are then flowed through respective fluid passageways into the passageway merging area and mixed and diluted with each other.

The present embodiment of the testing device comprises three essential constitutional elements, including 1) closing means disposed between the blood processing chamber and the hemolyzing process fluid passageway portion, for closing the hemolyzing process fluid passageway to have any fluid prevented from being flowed between the hemolyzing process fluid passageway portion and the blood processing chamber, which the blood specimen is flowed into, 2) fluid stopping means constituted by a capillary valve for stopping a fluid from being flowed by a capillary action, and 3) an outflow fluid passageway portion extending from the hemolyzing process fluid passageway portion to the passageway merging area including an upper outflow fluid passageway portion disposed inwardly of an upper surface of the blood processing chamber toward the rotation center and a lower outflow fluid passageway portion disposed outwardly of a lower surface of the blood processing chamber from the rotation center.

The first constitutional element 1) is important because the fluid is flowed between the hemolyzing process fluid passageway portion and the blood processing chamber toward a direction to which a centrifugal force is exerted for while the device is rotated and the centrifugal force is exerted on the fluid, and thus the hemolyzed blood fluid cannot be diluted at the predetermined dilution ratio unless the hemolyzing process fluid passageway is closed to have any fluid prevented from being flowed between the hemolyzing process fluid passageway portion and the blood processing chamber.

The second constitutional element 2) functions to prevent the blood specimen from being flowed into the hemolyzing process fluid passageway by the capillary action when the blood specimen is introduced into the blood processing chamber.

The third constitutional element 3) is important because the fluid flowed beyond the fluid stopping means constituted by the capillary valve by the centrifugal force is thus held in predetermined areas of the blood processing chamber and the lower outflow fluid passageway to such an extent that a surface of the fluid contained in the blood processing chamber is equal in a distance from the rotation center of the testing device to a surface of the fluid contained in the lower outflow fluid passageway. More preferably, the upper outflow fluid passageway portion is in the form of an inverted U shape having a turnup portion disposed inwardly of the upper surface of the blood processing chamber toward the rotation center of the testing device. As a result of the rotation of the testing device, the blood specimen is thus separated into blood cells and a blood plasma fluid while the hemolyzed blood fluid is separated from impurities.

The present embodiment of the testing device is substantially the same as the first embodiment of the testing device except for the facts, which have been described earlier. The hemolyzed blood fluid is then mixed and diluted with the blood plasma fluid at a predetermined dilution ratio.

In the present embodiment, the closing means may be operative to cause a chemical change between the blood processing chamber and the hemolyzing process fluid passageway portion to close the hemolyzing process fluid passageway to have any fluid prevented from being flowed between the hemolyzing process fluid passageway portion and the blood processing chamber. For example, blood coagulation factors may efficiently function as the closing means.

### Third Preferred Embodiment

The third preferred embodiment of the testing device according to the present invention will be described hereinlater.

The present embodiment of the testing device is more effective than the previous embodiments for the case that the dilution ratio is extremely high, and in which the one or more diluting fluid passageways have the diluting fluid flowed through the passageway merging area toward a predetermined direction, and the specimen fluid passageway is capable of having the specimen sample temporarily held in the passageway merging area, to have the specimen sample mixed and diluted with the diluting fluid at a predetermined ratio.

In the present embodiment, the specimen fluid passageway and each of the one or more diluting fluid passageways are intersected by and held in fluid communication with each other at the passageway merging area through a space, constituted by, for example, a capillary valve greater in width than the other neighboring portion of each of the specimen fluid passageway and the one or more diluting fluid passageways. In the present embodiment, the position of the capillary valve plays essential roles. The present embodiment of the testing device further comprises an extension fluid passageway having an end portion held in fluid communication with the specimen fluid passageway at the passageway merging area through a space constituted by, for example, a capillary valve greater in width than the other neighboring portion of the specimen fluid passageway and the extension fluid passageway. The specimen fluid passageway is disposed between and spaced apart from the one or more diluting fluid passageways and the end portion of the extension fluid passageway through respective capillary valves.

The present embodiment of the testing device thus constructed can prevent the specimen fluid flowed through the specimen fluid passageway and the diluting fluid flowed through each of the one or more diluting fluid passageways from being further flowed by a capillary action and thus mixed with each other after the first rotation of the present embodiment of the testing device is terminated, and the blood separating process and the blood hemolyzing process are completed. Air must be flowed in order to have fluids flowed respectively through the specimen fluid passageways and the one or more diluting fluid passageways. Therefore, in the present embodiment, each of the specimen fluid passageways and the one or more diluting fluid passageways has an end portion held in fluid communication with an air opening.

When the testing device is again rotated, the specimen sample temporarily held in the passageway merging area is mixed and diluted with the diluting fluid at a predetermined ratio. The present embodiment of the testing device can mix and dilute the specimen sample with the diluting fluid at an extremely high dilution ratio, resulting from the fact that the diluting fluid is excessively flowed through the passageway merging area in comparison with the specimen sample held in the passageway merging area. In the present embodiment, the specimen sample held in the passageway merging area is not flowed out while the specimen sample is mixed and diluted with the diluting fluid, resulting from the fact that the specimen fluid passageway includes a pair of turnup portions each disposed outwardly of the blood processing chamber from the rotation center, and the passageway merging area is disposed between the pair of turnup portions. In the present embodiment, the dilution ratio can be determined based on a ratio of the amount of the specimen sample held in an area around the passageway merging area to the amount of the diluting fluid flowed through the passageway merging area. This means that the dilution ratio is adjustable based on the capacity of the area around the passageway merging area and the flow volume of the diluting fluid flowed through the passageway merging area.

### Fourth Preferred Embodiment

The fourth preferred embodiment of the blood mixing and diluting method according to the present invention will be described hereinlater.

The present embodiment of the blood mixing and diluting method comprises an introducing step of introducing a blood specimen into a testing device; a dividing step of dividing the blood specimen introduced into the testing device in the introducing step into a first blood portion to be hemolyzed and a second blood portion to be separated into a blood plasma and blood cells; a blood cell and blood plasma obtaining step of rotating the testing device to have the first blood portion hemolyzed and the second blood portion separated into blood cells and a blood plasma; a fluid flowing step of stopping the testing device from rotating to have a fluid of the hemolyzed blood, i.e., and a hemolyzed blood fluid and the blood plasma flowed through respective fluid passageways; a mixing and diluting step of rotating the testing device to have the hemolyzed blood fluid mixed and diluted with the blood plasma.

As will be seen from the foregoing description, the present embodiment of the blood mixing and diluting method can divide a blood specimen into a first blood portion and a second blood portion, hemolyze the first blood portion and separate the second blood portion into blood cells and a blood plasma, and mix and dilute the hemolyzed blood fluid with the blood plasma only by controlling the testing device to be rotated or stopped from being rotated.

### Fifth Preferred Embodiment

The fifth preferred embodiment of the testing device according to the present invention will be described hereinlater.

The present embodiment of the testing device comprises a blood separating chamber held in fluid communication with the specimen inlet means to receive a blood specimen to have therein the blood specimen hemolyzed and separated into a blood plasma and blood cells while the testing device is rotated, a diluting fluid introducing chamber for introducing thereinto a diluting fluid for diluting components forming part of the blood specimen, and a mixing chamber for receiving the blood plasma and the diluting fluid to have the blood plasma mixed with and diluted with the diluting fluid while the testing device is rotated, and the blood separating chamber has accommodated therein a hemolyzing agent for hemolyzing components forming part of the blood specimen. The present embodiment of the testing device can carry out preprocesses, viz., a blood separating process, a blood hemolyzing process, and a diluting process only by introducing a blood specimen and a diluting fluid into the testing device and controlling the testing device to be rotated and stopped from being rotated, thereby making it possible for the present embodiment of the testing device to be small in size and excellent in portability and operability and require a minimal amount of external fluid such as, for example, a buffer fluid, and the like to be introduced therein in comparison with the conventional testing device.

It is preferable that a total capacity of the present embodiment of the testing device is capable of having introduced therein equal to or greater than an amount of the diluting fluid required to dilute all of the components forming part of the blood specimen, thereby preventing the diluting fluid from overflowing therefrom. Further, it is preferable that an amount of the hemolyzing agent accommodated in the blood separating chamber falls short of hemolyzing the entire blood specimen accommodated in the blood separating chamber. To hemolyze a blood specimen with an amount of the hemolyzing agent less than that of the hemolyzing agent required to hemolyze whole of the blood specimen will be hereinlater referred to as “partial hemolysis” or “partially hemolyze a blood specimen”. The present embodiment of the testing device thus constructed can partially hemolyze the blood specimen accommodated in the blood separating chamber, and thus lessen an amount of hemolyzed blood fluid to be made, thereby reducing the amount of the diluting fluid required to be introduced therein.

According to the present invention, the testing device may partially hemolyze the blood specimen for a plurality of times. Partially hemolyzing a blood specimen for a plurality of times will be hereinlater referred to as “multistage partial hemolysis”. The multistage partial hemolysis makes it possible for the testing device to obtain a required amount of hemolyzed blood fluid with a greatly reduced amount of hemolyzing agent. The present embodiment of the testing device according to the present invention may further comprise one or more additional chambers each having accommodated therein said hemolyzing agent, and an amount of said hemolyzing agent accommodated in each of said one or more hemolyzed blood chambers falls short of hemolyzing all of said blood specimen accommodated in said one or more hemolyzed blood chambers. The testing device according to the present invention thus constructed can partially hemolyze the blood specimen for a plurality of times, and thus further lessen an amount of hemolyzed blood fluid to be made, thereby reducing the amount of the hemolyzing agent as well as that of the diluting fluid required to be introduced therein.

### Sixth Preferred Embodiment

The sixth embodiment of the blood mixing and diluting method according to the present invention will be described hereinlater.

The present embodiment of the blood mixing and diluting method comprises an introducing step of introducing a blood specimen into the testing device; a diluting fluid introducing step of introducing a diluting fluid for diluting the components forming part of the blood specimen; a hemolyzing and separating step of rotating the testing device to have the blood specimen hemolyzed and separated into blood cells and a hemolyzed blood plasma; a fluid flowing step of stopping the testing device from rotating to have a fluid from the hemolyzed blood plasma and the diluting fluid flowed; and a mixing and diluting step of rotating the testing device to have the fluid from the hemolyzed blood plasma mixed with the diluting fluid.

As will be seen from the foregoing description, the present embodiment of the blood mixing and diluting method can carry out a preprocess of measuring, for example, hemoglobins only while the testing device is controlled to be rotated and stopped from being rotated, thereby making it possible for the testing device to be small in size, excellent in portability and operability, and require a minimal amount of external fluid such as, for example, a buffer fluid, and the like to be introduced therein in comparison with the conventional testing device.

### First Example

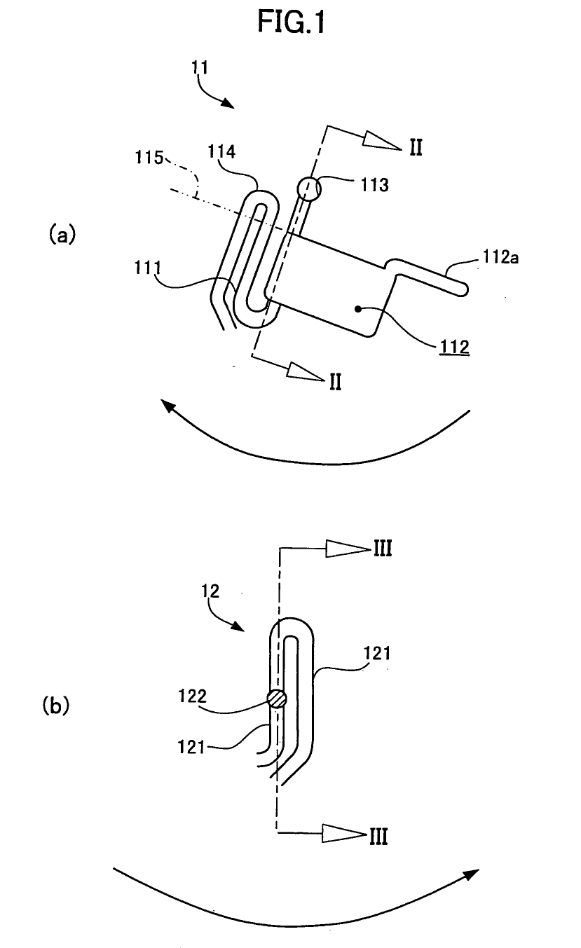

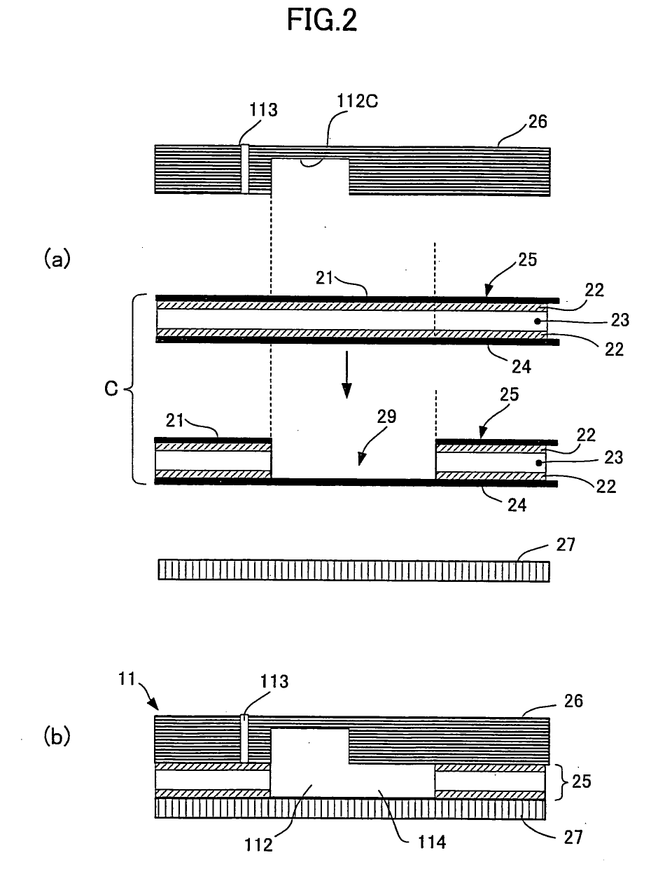

Referring now to FIGS. 1 to 3 of the drawings, there is shown a first example of a testing device according to the present invention. The present example of the testing device comprises first and second passageway parts as shown in FIGS. 1 and 2. FIG. 1(a) is a block diagram showing a basic passageway part constituted by a first passageway part 11 forming part of the first example of the testing device according to the present invention. FIG. 1(b) is a block diagram showing a passageway portion including a capillary valve, constituted by a second passageway part 12 forming part of the testing device according to the present invention. The first passageway part 11 is constituted by a passageway 111 and a chamber 112 held in fluid communication with the passageway 111. The second passageway part 12 is constituted by a second passageway 121 having a capillary valve 122 formed therein. The capillary valve 122 is greater in width (cross-sectional area) than the other neighboring parts of the second passageway 121.

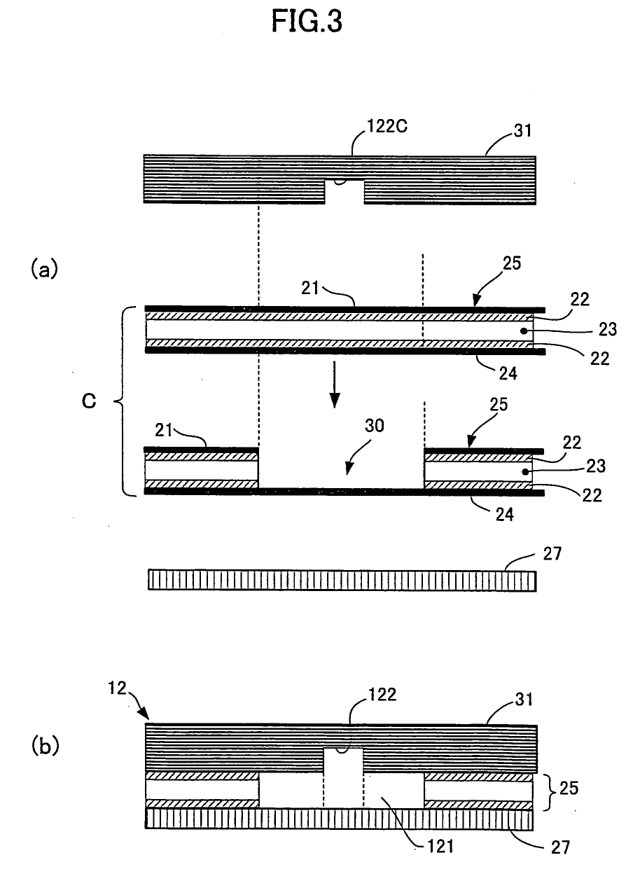

The construction of the first and second passageway parts will be firstly described with reference to FIG. 1, and the method of producing the first and second passageway parts will be later described with reference to FIGS. 2 and 3.

As clearly seen from FIG. 1 (a), the first passageway part 11 is constituted by a chamber 112 in which an analytical process such as, for example, dilution, mixing, reaction, or detection process is carried out, a passageway 111 and an air opening 113 held in fluid communication with the chamber 112. Further, the chamber 112 has an extension portion 112a formed therein. The extension portion 112a is available when there is provided another passageway required to be connected to and held in fluid communication with the chamber 112. The passageway 111 extends from the chamber 112 but spaced apart from the extension portion 112a across the chamber 112. The air opening 113 is provided spaced apart from the passageway 111 and the extension portion 112a across the chamber 112.

The testing device is rotatable around a rotation center. The chamber 112 has an upper surface 115 close to the rotation center. The first passageway part 111 includes a passageway portion in the form of an inverted U shape having a turnup portion 114 disposed inwardly of the upper surface 115 of the chamber 112 toward the rotation center of the testing device. The first passageway part 111 thus constructed can hold fluid in the chamber 112 and the passageway part 111 positioned outwardly of the turnup portion 114 from the rotation center toward the chamber 112 with a centrifugal force while the testing device is rotating. On the contrary, the turnup portion 114 may be disposed outwardly of the upper surface 115 of the chamber 112 from the rotation center if the fluid is required to be flowed incessantly.

In the present example, the turnup portion 114 is disposed inwardly of the upper surface 115 of the chamber 112 toward the rotation center because of the fact that the fluid is required to be temporarily held in the chamber 112.

As clearly seen from FIG. 1(b), the second passageway part 12 is as a whole in the form of an inverted U shape, and constituted by a second passageway 121 having a capillary valve 122 formed therein. The second passageway 121 has both end portions inclined toward the lateral direction. The capillary valve 122 is formed in the second passageway 121 and defines a space greater in width (cross-sectional area) than the other neighboring portions of the second passageway 121. The second passageway 121 can be divided into an inflow passageway portioned prior to the capillary valve 122 and an outflow passageway portion positioned subsequent to the capillary valve 122 along a direction of a fluid flowing through the second passageway 121. The capillary valve 122 of the second passageway part 12 serves as intercepting means for intercepting a fluid by a capillary action between the inflow passageway portion and the outflow passageway portion. The fact that the capillary valve 122 defines a space greater in width (cross-sectional area) than the other neighboring portions of the second passageway 121 leads to the fact that the fluid is intercepted and brought into a stationary state in a predetermined portion of the second passageway 121, and thus prevented from flowing through the second passageway 121 after the testing device is stopped from being rotated. In the present example, the passageway is formed with a capillary valve in consideration of a position, a timing, and a zone of intercepting the fluid.

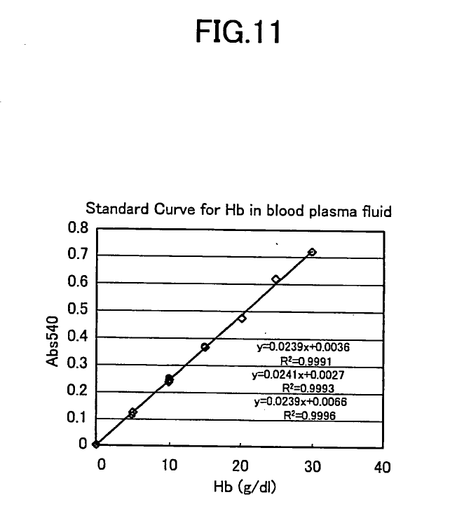

FIGS. 2 and 3 are cross sectional views for explaining how the first and second passageway parts shown in FIG. 1 are produced. As clearly seen from FIGS. 2 and 3, each of the first and second passageway parts includes three layers. FIG. 2(a) is a cross sectional view for explaining how the first passageway part 11 shown in FIG. 1(a) is produced, FIG. 2(b) is a cross sectional view taken along the line II-II of FIG. 1(a). FIG. 3(a) is a cross sectional view for explaining how the second passageway part 12 shown in FIG. 11(b) is produced, and FIG. 3(b) is a cross sectional view taken along the line III-III of FIG. 1(b).

The method of producing the first passageway part 11 will be described in detail with reference to FIG. 2.

The method of producing the first passageway part 11 is performed through the steps including a preparing step, a cutting step, a coating step, and an adhering step as follows.

As clearly seen from FIG. 2(b), the first passageway part 11 comprises a base substrate 27, a top cover 26, and a two-sided adhesive sheet 25 intervening between the base substrate 27 and the top cover 26. In the preparing step, the base substrate 27, the top cover 26, and a raw two-sided adhesive sheet 21 are prepared as a partially fabricated unit. The raw two-sided adhesive sheet 21 is manufactured by FLEXCON Corporation, and includes a backing layer 23 having a width of 50 μm, upper and lower adhesive layers 22 each having a width of 25 μm, and release papers 24.

In the cutting step, the raw two-sided adhesive sheet 21 is machined by a cutting plotter manufactured by GRAPHTEC Corporation to cut off a cut-off portion 29 corresponding to a space defined by the chamber 112 and the passageway 111 to produce a two-sided adhesive sheet 25. In this cutting step, the raw two-sided adhesive sheet 21 is firstly incised except for the lower release paper 24, and then the cut-off portion 29 is picked away from the raw two-sided adhesive sheet 21.

In the coating step, the base substrate 27 is coated with polystyrene, hereinlater simply referred to as “PS”. Preferably, the base substrate 27 is spin coated with a solution of polystyrene (manufactured by Sigma-Aldrich Corporation) in 2-acetoxy-1-methoxy propane at a concentration rate of 1% (weight/volume), followed by drying under vacuum overnight. Further, the base substrate 27 is spin coated with a surface acting agent, followed by drying under vacuum overnight. The base substrate 27 thus coated with the surface active agent is increased in hydrophilic property and improved in flow property. In the present example, the base substrate 27 is in the form of a disc shape and made of polycarbonate.

The top cover 26 is in advance perforated and then molded to have formed therein an air opening 113 and a recess portion 112C corresponding to the chamber 112.

In the adhering step, the base substrate 27 thus spin coated (PS coated base substrate) and the top cover 26 are adhered to each other through the two-sided adhesive sheet 25 to produce a first passageway part 11.

While it has been described in the above that in the coating step the base substrate 27 is firstly spin coated with the PS and secondly with the surface active agent, according to the present invention, the base substrate 27 may be firstly spin coated with the surface active agent, and secondly with the PS, or the base substrate 27 may be spin coated with the surface active agent in place of the PS.

The method of producing the second passageway part 12 will be described in detail with reference to FIG. 3.

Similar to the first passageway part 11, the method of producing the second passageway part 12 is performed through the steps including a preparing step, a cutting step, a coating step, and an adhering step.

As clearly seen from FIG. 3(b), the second passageway part 12 comprises a base substrate 27, a top cover 31, and a two-sided adhesive sheet 25 intervening between the base substrate 27 and the top cover 31. The preparing step, the coating step, the cutting step and the adhering step are almost the same as those of the method of producing the first passageway part 11 except for the fact that the raw two-sided adhesive sheet 21 is machined by the cutting plotter to cut off a cut-off portion 30 corresponding to a space defined by the second passageway 121 and the capillary valve 122 to produce a two-sided adhesive sheet 25 in the cutting step, and the top cover 31 is perforated and then molded to have formed therein a recess portion 122C corresponding to the capillary valve 122. In the adhering step, the base substrate 27 and the top cover 31 are adhered to each other through the two-sided adhesive sheet 25 to produce a second passageway part 12.

The following examples of the testing devices according to the present invention can be made by adaptively combining the base passageway parts, i.e., connecting an appropriate number of the first passageway parts 11 and the second passageway parts 12 in accordance with functions of the testing devices.

### Second Example

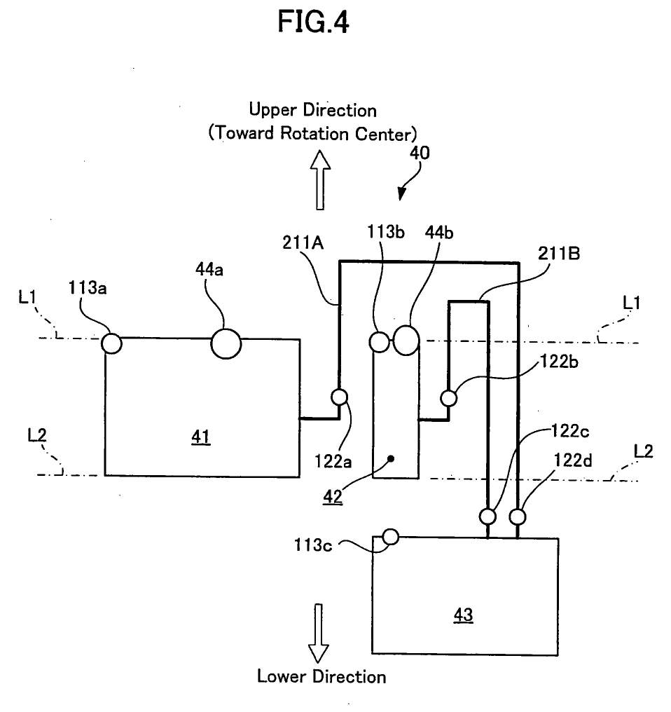

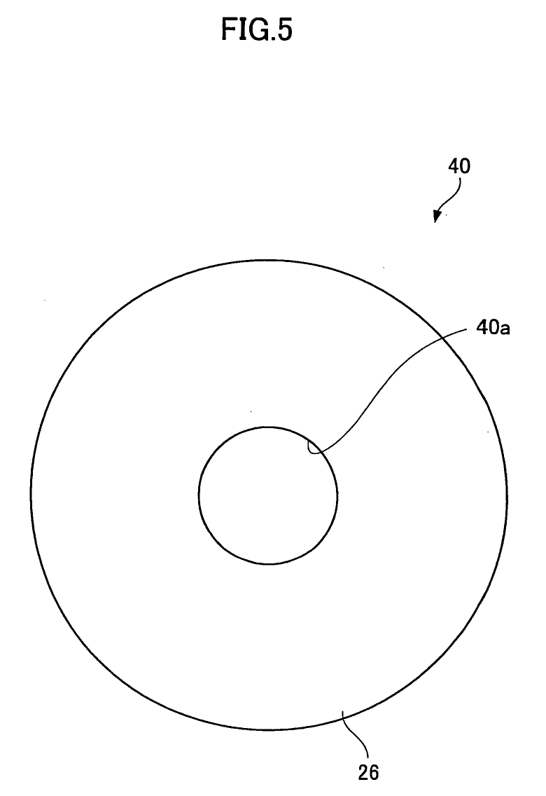

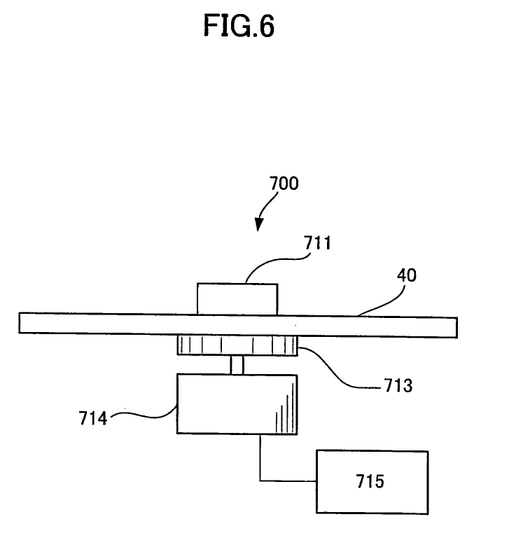

Referring now to FIGS. 4 to 6 of the drawings, there is shown a second example of a testing device according to the present invention. FIG. 4 is a schematic view showing the second example of the testing device according to the present invention. FIG. 5 is a schematic top view showing the present example of the testing device according to the present invention. FIG. 6 is a schematic view showing a rotating device for rotating the testing device.

The construction of the present example of the testing device will be firstly described with reference to FIG. 4 and the operation of mixing and diluting a hemolyzed blood fluid with blood plasma carried out by the present example of the testing device will be described later.

As clearly seen from FIG. 4, the present example of the testing device denoted by a reference numeral 40 comprises therein a blood separating chamber 41, a hemolyzed blood chamber 42, and a mixing chamber 43. The testing device 40 is rotatable around a rotation center, not shown in FIG. 4. As described in the above, the testing device 40 is produced by adaptively connecting an appropriate number of the first passageway parts 11 and the second passageway parts 12 shown in FIG. 1. As clearly seen from FIG. 5, the present example of the testing device 40 is in the form of a disc shape having a central hole 40a. As will be clearly seen from FIG. 4, the testing device 40 is illustrated as being composed of the blood separating chamber 41, the hemolyzed blood chamber 42, and the mixing chamber 43 for the purpose of simplifying the description and assisting in understanding about the whole operation of the testing device 40. In reality, it is needless to mention that the testing device 40 may further comprise additional chambers, fluid passageways, and the like, other than those shown in FIG. 4, as required.

Here, the blood separating chamber 41 has a volume capable of having introduced therein 70 μl of blood. The hemolyzed blood chamber 42 has a volume capable of having introduced therein 5 μl of hemolyzed blood fluid. The blood separating chamber 41 has formed therein an air opening 113a, an inlet port 44a, and an outlet port, not shown, held in fluid communication with a fluid passageway 211A. The fluid passageway 211A is formed with a capillary valve 122a in the vicinity of the blood separating chamber 41. The hemolyzed blood chamber 42 has formed therein an air opening 113b, an inlet port 44b, and an outlet port, not shown, held in fluid communication with a fluid passageway 211B. The fluid passageway 211B is formed with a capillary valve 122b in the vicinity of the hemolyzed blood chamber 42. The mixing chamber 43 has formed therein an air opening 113c, inlet ports, not shown, respectively held in fluid communication with the fluid passageway 211A and the fluid passageway 2111B. The fluid passageway 211A is formed with a capillary valve 122d in the vicinity of the mixing chamber 43. The fluid passageway 211B is formed with a capillary valve 122c in the vicinity of the mixing chamber 43. This means that the fluid passageway 211A has two capillary valves 122a and 122d, and the fluid passageway 211B has two capillary valves 122b and 122c.

The blood separating chamber 41 has an upper surface facing toward the rotation center of the testing device 40 and a lower surface opposing to the upper surface. The upper surface of the blood separating chamber 41 is represented by a dotted line L1 passing thereon. The lower surface of the blood separating chamber 41 is represented by a dotted line L2 passing thereon. As will be clearly seen from FIG. 4, the dotted line L1 and the dotted line L2 are illustrated as straight lines for the purpose of simplifying the description and assisting in understanding about the whole operation of the testing device 40. In reality, the upper surface and the lower surface of the blood separating chamber 41 are disposed in concentric relationship with the rotation center of the testing device 40. Therefore, the dotted lines L1 and L2 are circular arcs respectively disposed in concentric relationship with the rotation center of the testing device 40. The fluid passageway 211A extending from the blood separating chamber 41 to a passageway merging area constituted by the mixing chamber 43, includes an upper fluid passageway portion positioned inwardly of the upper surface of the blood separating chamber 41 toward the rotation center of the testing device 40 (inwardly of the line L1 toward the rotation center of the testing device 40), and a lower fluid passageway portion positioned outwardly of the lower surface of the blood separating chamber 41 from the rotation center of the testing device 40 (outwardly of the line L2 from the rotation center of the testing device 40). Likewise, the fluid passageway 2111B extending from the hemolyzed blood chamber 42 to the mixing chamber 43 includes an upper fluid passageway portion positioned inwardly of the upper surface of the blood separating chamber 41 toward the rotation center of the testing device 40 (inwardly of the line L1 toward the rotation center of the testing device 40), and a lower fluid passageway portion positioned outwardly of the lower surface of the blood separating chamber 41 from the rotation center of the testing device 40 (outwardly of the line L2 from the rotation center of the testing device 40).

The testing device 40 is mounted on and rotated by, for example, a rotating device 700 shown in FIG. 6. The rotating device 700 comprises a damper 711 for holding the testing device 40 under the state that the damper 711 of the rotating device 700 is received in the central hole 40a of the testing device 40, a turntable 713 for supporting the testing device 40, a spindle motor 714 for driving the turntable 713 to have the testing device rotated, and a control unit 715 for controlling the spindle motor 714. The rotating device 700 thus constructed is operative to rotate and stop from rotating the testing device 40 for predetermined time intervals.

The operation of the present example of the testing device 40 according to the present invention will be described hereinlater.

In the present example, as the specimen was used a whole blood specimen (to be used for whole blood test), and as the hemolyzed blood fluid was used a solution prepared by adding 1 g of potassium chloride to 1 ml of blood contained in an Eppendorf tube (a tube manufactured Eppendorf) to be adequately mixed with each other.

70 μl of the whole blood specimen was firstly introduced into the blood separating chamber 41 through the inlet port 44a. The whole blood specimen can be introduced into the blood separating chamber 41 with ease because of the fact that the blood separating chamber 41 has formed therein the air opening 113a. The whole blood specimen permeated through the fluid passageway 211A by a capillary action and then came to a stationary state at the capillary valve 122a. Likewise, 5 μl of the hemolyzed blood fluid was introduced into the hemolyzed blood chamber 42 through the inlet port 44b. The hemolyzed blood fluid introduced into the hemolyzed blood chamber 42 was prepared using the blood cells separated from the whole blood specimen in the blood separating chamber 41. The hemolyzed blood fluid can be introduced into the hemolyzed blood chamber 42 with ease because of the fact that the hemolyzed blood chamber 42 has formed therein the air opening 113b. The hemolyzed blood fluid permeated through the fluid passageway 211B by a capillary action and came to a stationary state at the capillary valve 122b.

The testing device 40 was then rotated by the rotating device 700 at 4000 rpm (rotation per minute) for four minutes to separate the whole blood specimen contained in the blood separating chamber 41 into blood cells and blood plasma. While the testing device 40 was rotated, the fluid (the blood plasma separated from the whole blood specimen) contained in the blood separating chamber 41 flowed through the fluid passageway 211A beyond the capillary valve 122a to a passageway point equal in a distance from the rotation center of the testing device 40 to a surface of the fluid contained in the blood separating chamber 41. Likewise, while the testing device 40 was rotated, the fluid (hemolyzed blood fluid) contained in the hemolyzed blood chamber 42 flowed through the fluid passageway 211B beyond the capillary valve 122b to a passageway point equal in a distance from the rotation center of the testing device 40 to a surface of the fluid contained in the hemolyzed blood chamber 42.

After the testing device 40 was stopped from being rotated, the blood plasma was further flowed through the fluid passageway 211A to the capillary valve 122d stopped short of the mixing chamber 43 by a capillary action. The blood plasma can be flowed through the fluid passageway 211A with ease by a capillary action because of the fact that the mixing chamber 43 has formed therein the air opening 113c. Likewise, after the testing device 40 was stopped from being rotated, the hemolyzed blood fluid was further flowed through the fluid passageway 211B to the capillary valve 122c stopped short of the mixing chamber 43 by a capillary action. The hemolyzed blood fluid can be flowed through the fluid passageway 211B with ease by a capillary action because of the fact that the mixing chamber 43 has formed therein the air opening 113c.

The testing device 40 was again rotated by the rotating device 700 at 1500 rpm (rotation per minute) for one minute and then stopped from being rotated to have the blood plasma further flowed through the fluid passageway 211A from the capillary valve 122d to the mixing chamber 43 and the hemolyzed blood fluid further flowed through the fluid passageway 211B from the capillary valve 122c to the mixing chamber 43. The blood plasma and the hemolyzed blood fluid were thus mixed with each other in the mixing chamber 43, and a diluted fluid (mixed and diluted fluid) was obtained.

From the foregoing description, it is to be understood that the present example of the testing device and the blood mixing and diluting method can mix and dilute the hemolyzed blood fluid with the blood plasma separated from the whole blood specimen while the present example of the testing device is rotated and stopped from being rotated under predetermined conditions.

### Third Example

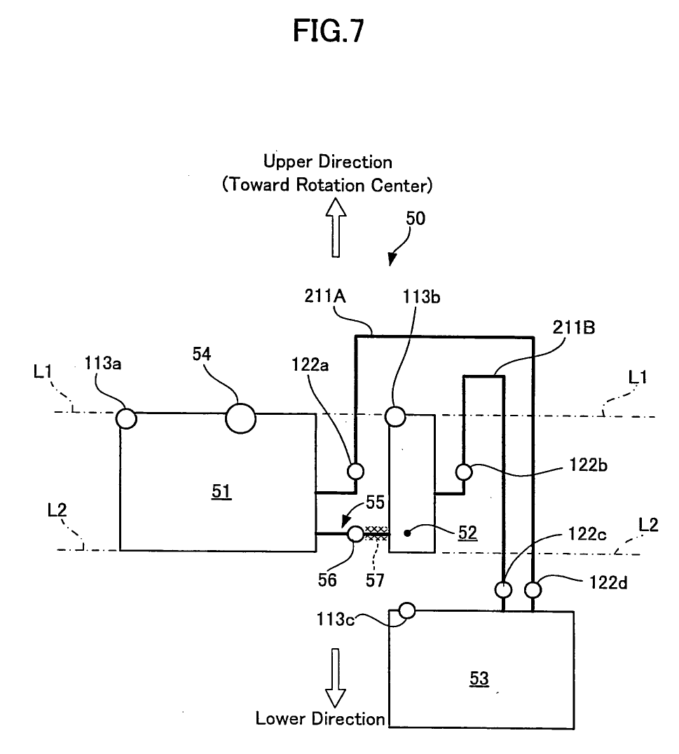

Referring to FIG. 7 of the drawings, there is shown a third example of a testing device according to the present invention. The construction of the present example of the testing device will be firstly described with reference to FIG. 7 and the operation of mixing and diluting a hemolyzed blood fluid with blood plasma carried out by the present example of the testing device will be described later. The constituent elements of the present example the same as those of the previous example have respective reference numerals the same as those of the previous example and will thus not be described hereinlater.

As clearly seen from FIG. 7, the present example of the testing device denoted by a reference numeral 50 comprises therein a blood separating chamber 51, a hemolyzed blood chamber 52, and a mixing chamber 53. The testing device 50 is rotatable around a rotation center, not shown. As described in the above, the testing device 50 is produced by adaptively connecting an appropriate number of the first passageway parts 11 and the second passageway parts 12 shown in FIG. 1. The present example of the testing device can mix and dilute a hemolyzed blood fluid with blood plasma using only a whole blood specimen once introduced therein while the present example of the testing device is rotated and stopped from being rotated under predetermined conditions.

Here, the blood separating chamber 51 has a volume capable of having introduced therein 70 μl of blood. The hemolyzed blood chamber 52 has a volume capable of having introduced therein 5 μl of hemolyzed blood fluid. The blood separating chamber 51 has formed therein an air opening 113a, an inlet port 54, and a first outlet port, not shown, held in fluid communication with a fluid passageway 211A. The fluid passageway 211A is formed with a capillary valve 122a in the vicinity of the blood separating chamber 51. The hemolyzed blood chamber 52 has formed therein an air opening 113b, and an outlet port, not shown, held in fluid communication with a fluid passageway 211B. The fluid passageway 211B is formed with a capillary valve 122b in the vicinity of the hemolyzed blood chamber 52. The mixing chamber 53 has formed therein an air opening 113c, inlet ports, not shown, respectively held in fluid communication with the fluid passageway 211A and the fluid passageway 211B. The fluid passageway 211A is formed with a capillary valve 122d in the vicinity of the mixing chamber 53. The fluid passageway 211B is formed with a capillary valve 122c in the vicinity of the mixing chamber 53. This means that the fluid passageway 211A has two capillary valves 122a and 122d, and the fluid passageway 211B has two capillary valves 122b and 122c. The fluid passageway 211A and the fluid passageway 211B are thus similar in construction to those described in the previous example.

In the present example of the testing device 50, the blood separating chamber 51 and the hemolyzed blood chamber 52 are held in fluid communication with each other through a fluid passageway 55 extending between the blood separating chamber 51 and the hemolyzed blood chamber 52, as best shown in FIG. 7. The blood separating chamber 51 has a second outlet port, not shown, held in fluid communication with one end of the fluid passageway 55. The second outlet portion of the blood separating chamber 51 is disposed farther than the first outlet portion of the blood separating chamber 51 in distance from the rotation center of the testing device 50. Preferably, the second outlet port of the blood separating chamber 51 is disposed in the vicinity of an edge portion of the blood separating chamber located farthest away from the rotation center of the testing device 50. The hemolyzed blood chamber 52 has an inlet port, not shown, held in fluid communication with the other end of the fluid passageway 55. Preferably, the inlet port of the hemolyzed blood chamber 52 is disposed in the vicinity of an edge portion of the hemolyzed blood chamber 52 located farthest away from the rotation center of the testing device 50.

The fluid passageway 55 is formed with a capillary valve 56 (fluid stopping means). The fluid passageway 55 includes a passageway area having predetermined blood coagulation factors 57 (not shown in detail) accommodated therein. The passageway area is located between the capillary valve 56 and the inlet portion of the hemolyzed blood chamber 52. The hemolyzed blood chamber 52 has accommodated therein potassium chloride, not shown, as a hemolyzing agent. In the present example, the hemolyzed blood chamber 52 constitutes a hemolyzing process fluid passageway.

The hemolyzing agent accommodated in the hemolyzed blood chamber 52 can be prepared by, for example, applying a solution containing the hemolyzing agent to an inner surface of the hemolyzed blood chamber 52, and the drying the inner surface of the hemolyzed blood chamber 52 by freeze-drying. Likewise, the blood coagulation factors 57 can be accommodated in the passageway area by, for example, applying a solution containing the blood coagulation factors to an inner surface of the passageway area, and then drying the inner surface of the passageway area by freeze-drying.

The blood separating chamber 51 has an upper surface facing toward the rotation center of the testing device 50 and a lower surface opposing to the upper surface. The upper surface of the blood separating chamber 51 is represented by a dotted line L1 passing thereon. The lower surface of the blood separating chamber 51 is represented by a dotted line L2 passing thereon. As will be clearly seen from FIG. 7, the dotted line L1 and the dotted line L2 are illustrated as straight lines for the purpose of simplifying the description and assisting in understanding about the whole operation of the testing device 50. In reality, the upper surface and the lower surface of the blood separating chamber 51 are disposed in concentric relationship with the rotation center of the testing device 50. Therefore, the dotted lines L1 and L2 are circular arcs respectively disposed in concentric relationship with the rotation center of the testing device 50.

The fluid passageway 211A extending from the blood separating chamber 51 to a passageway merging area constituted by the mixing chamber 53, includes an upper fluid passageway portion positioned inwardly of the upper surface of the blood separating chamber 51 toward the rotation center of the testing device 50 (inwardly of the line L1 toward the rotation center of the testing device 50), and a lower fluid passageway portion positioned outwardly of the lower surface of the blood separating chamber 51 from the rotation center of the testing device 50 (outwardly of the line L2 from the rotation center of the testing device 50). Likewise, the fluid passageway 211B extending from the hemolyzed blood chamber 52 to the mixing chamber 53 includes an upper fluid passageway portion positioned inwardly of the upper surface of the blood separating chamber 51 toward the rotation center of the testing device 50 (inwardly of the line L1 toward the rotation center of the testing device 50), and a lower fluid passageway portion positioned outwardly of the lower surface of the blood separating chamber 51 from the rotation center of the testing device 50 (outwardly of the line L2 from the rotation center of the testing device 50).

The present example of the testing device 50 is mounted on and rotated by, for example, the rotating device 700 show in FIG. 6.

The operation of the present example of the testing device 50 according to the present invention and an example of a method of mixing and diluting a hemolyzed blood fluid carried out by the present example of the testing device 50 will be described later.

In the present example, as the specimen was used a whole blood specimen (to be used for whole blood test).

70 μl of the whole blood specimen was firstly introduced into the blood separating chamber 51 through the inlet port 54 to have the blood specimen introduced in the testing device 50 (introducing step). The whole blood specimen can be introduced into the blood separating chamber 51 with ease because of the fact that the blood separating chamber 51 has formed therein the air opening 113a. The whole blood specimen permeated through the fluid passageway 55 and the fluid passageway 211A by a capillary action and then came to a stationary state at the capillary valve 56 and the capillary valve 122a.

The testing device 50 was then rotated by the rotating device 700 at 4000 rpm (rotation per minute) for four minutes. While the testing device 50 was rotated, the whole blood specimen was flowed through the fluid passageway 55 beyond the capillary valve 56 by centrifugal force to the hemolyzed blood chamber 52 to such an extent that a surface of the fluid contained in the blood separating chamber 51 was approximately equal in a distance from the rotation center of the testing device 50 to a surface of the fluid contained in the hemolyzed blood chamber 52 before the whole blood specimen was separated into blood cells and blood plasma. Thus, the blood introduced into the testing device 50 is divided into blood to be used for a blood hemolyzing process and blood to be used for a blood separating process (dividing step).

The blood flowed into the fluid passageway 55 was reacted with the blood coagulation factors 57 (closing means) accommodated in the passageway area of the fluid passageway 55. The blood reacted with the blood coagulation factors 57 was coagulated after a predetermined time period was elapsed to close the fluid passageway 55. The blood separating chamber 51 and the hemolyzed blood chamber 52 were thus decoupled from each other.

The fluid contained in the blood separating chamber 51 was flowed through the fluid passageway 211A beyond the capillary valve 122a to such an extent that a surface of the fluid contained in the blood separating chamber 51 was approximately equal in a distance from the rotation center of the testing device 50 to a surface of the fluid flowed through the fluid passageway 211A. Likewise, the fluid contained in the hemolyzed blood chamber 52 was flowed through the fluid passageway 211B beyond the capillary valve 122b to such an extent that a surface of the fluid contained in the hemolyzed blood chamber 52 was approximately equal in a distance from the rotation center of the testing device 50 to a surface of the fluid flowed through the fluid passageway 211B.

The testing device 50 was continuously rotated by the rotating device 700 for ten minutes to have the blood contained in the blood separating chamber 51 sufficiently separated into blood cells and blood plasma (blood separating process (blood cell and blood plasma obtaining step)), and to have, likewise, the blood contained in the hemolyzed blood chamber 52 sufficiently hemolyzed with the hemolyzing agent accommodated in the hemolyzed blood chamber 52 (hemolyzing process).

After the testing device 50 was stopped from being rotated, the blood plasma was further flowed through the fluid passageway 211A to the capillary valve 122d stopped short of the mixing chamber 53 by a capillary action. The blood plasma can be flowed through the fluid passageway 211A with ease by a capillary action because of the fact that the mixing chamber 53 has formed therein the air opening 113c. Likewise, after the testing device 50 was stopped from being rotated, the hemolyzed blood fluid was further flowed through the fluid passageway 211B to the capillary valve 122c stopped short of the mixing chamber 53 by a capillary action (fluid flowing step). The hemolyzed blood fluid can be flowed through the fluid passageway 211B with ease by a capillary action because of the fact that the mixing chamber 53 has formed therein the air opening 113c.

The testing device 50 was again rotated by the rotating device 700 at 1500 rpm (rotation per minute) for one minute and then stopped from being rotated to have the blood plasma further flowed through the fluid passageway 211A from the capillary valve 122d to the mixing chamber 53 and the hemolyzed blood fluid further flowed through the fluid passageway 211B from the capillary valve 122c to the mixing chamber 53. The blood plasma and the hemolyzed blood fluid were thus mixed with each other in the mixing chamber 53, and a diluted fluid (mixed and diluted fluid) was obtained (mixing and diluting process (step)).

While it has been described in the present example, the hemolyzing process fluid passageway is constituted by the hemolyzed blood chamber 52, the hemolyzing process fluid passageway may be constituted by any other fluid passageway or chamber as long as the hemolyzed blood fluid can be flowed into the mixing chamber 53. The hemolyzing process fluid passageway may be constituted by, for example, a fluid passageway 211B. In this case, the fluid passageway 211B may have accommodated therein a hemolyzing agent.

From the foregoing description, it is to be understood that the present example of the testing device and the blood mixing and diluting method can mix and dilute a hemolyzed blood fluid with blood plasma using only a whole blood specimen once introduced therein while the present example of the testing device is rotated and stopped from being rotated under predetermined conditions, resulting from the fact that the present example of the testing device comprising a blood separating chamber 51 and a hemolyzed blood chamber 52 held in fluid communication with each other through a fluid passageway 55 formed with a capillary valve 56, the fluid passageway 55 has accommodated therein blood coagulation factors 57, and the hemolyzed blood chamber 52 has accommodated therein a hemolyzing agent.

### Fourth Example

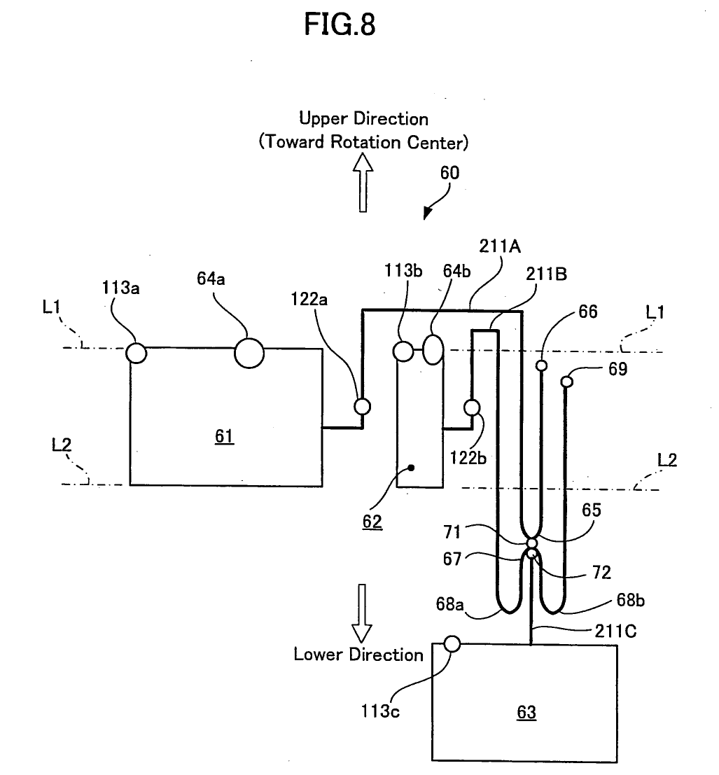

Referring to FIG. 8 of the drawings, there is shown a third example of a testing device according to the present invention. The construction of the present example of the testing device will be firstly described with reference to FIG. 8 and the operation of mixing and diluting a hemolyzed blood fluid with blood plasma carried out by the present example of the testing device will be described later. The constituent elements of the present example the same as those of the previous example have respective reference numerals the same as those of the previous example and will thus not be described hereinlater.

As clearly seen from FIG. 8, the present example of the testing device denoted by a reference numeral 60 comprises therein a blood separating chamber 61, a hemolyzed blood chamber 62, and a mixing chamber 63. The testing device 60 is rotatable around a rotation center, not shown. As described in the above, the testing device 60 is produced by adaptively connecting an appropriate number of the first passageway parts 11 and the second passageway parts 12 shown in FIG. 1. The present example of the testing device can mix and dilute a hemolyzed blood fluid with blood plasma separated from blood at an extremely high dilution ratio while the present example of the testing device is rotated and stopped from being rotated under predetermined conditions.

Here, the blood separating chamber 61 has a volume capable of having introduced therein 70 μl of blood. The hemolyzed blood chamber 62 has a volume capable of having introduced therein 5 μl of hemolyzed blood fluid. The blood separating chamber 61 has formed therein an air opening 113a, an inlet port 64a, and an outlet port, not shown, held in fluid communication with a fluid passageway 211A. The fluid passageway 211A is formed with a capillary valve 122a in the vicinity of the blood separating chamber 61. The hemolyzed blood chamber 62 has formed therein an air opening 113b, an inlet port 64b, and an outlet port, not shown, held in fluid communication with a fluid passageway 211B. The fluid passageway 211B is formed with a capillary valve 122b in the vicinity of the hemolyzed blood chamber 62. The mixing chamber 63 has formed therein an air opening 113c, and an inlet port, not shown, held in fluid communication with an extended fluid passageway constituted by a fluid passageway 211C.

The blood separating chamber 61 has an upper surface facing toward the rotation center of the testing device 60 and a lower surface opposing to the upper surface. The upper surface of the blood separating chamber 61 is represented by a dotted line L1 passing thereon. The lower surface of the blood separating chamber 61 is represented by a dotted line L2 passing thereon. As will be clearly seen from FIG. 8, the dotted line L1 and the dotted line L2 are illustrated as straight lines for the purpose of simplifying the description and assisting in understanding about the whole operation of the testing device 60. In reality, the upper surface and the lower surface of the blood separating chamber 61 are disposed in concentric relationship with the rotation center of the testing device 60. Therefore, the dotted lines L1 and L2 are circular arcs respectively disposed in concentric relationship with the rotation center of the testing device 60.

In the present example of the testing device 60, the fluid passageway 211A has one end held in fluid communication with the blood separating chamber 61 and the other end formed with an air opening 66 as clearly seen from FIG. 8. The fluid passageway 211A extending between the blood separating chamber 61 and the air opening 66 has a turnup portion 65 disposed outwardly of the lower surface of the blood separating chamber 61 from the rotation center of the testing device 60 (outwardly of the line L2 from the rotation center of the testing device 60). The turnup portion 65 is in the form of a U shape. Likewise, the fluid passageway 211B has one end held in fluid communication with the hemolyzed blood chamber 62 and the other end formed with an air opening 69 as clearly seen from FIG. 8. The fluid passageway 211B extending between the hemolyzed blood chamber 62 and the air opening 69 has a pair of turnup portions 68a and 68b in the form of inverted U shapes, and a turnup portion 67 in the form of a U shape and intervening between the turnup portions 68a and 68b. The turnup portion 67 is disposed outwardly of the lower surfaces of the blood separating chamber 61, the hemolyzed blood chamber 62, and the turnup portion 65 of the fluid passageway 211A from the rotation center of the testing device 60. The turnup portions 68a and 68b are disposed further outwardly of the turnup portion 67 from the rotation center of the testing device 60.

The turnup portion 65 forming part of the fluid passageway 211A and the turnup portion 67 are held in fluid communication with each other through a capillary valve 71. The turnup portion 67 and the mixing chamber 63 are held in fluid communication with each other through a capillary valve 72 other than the capillary valve 71. Thus, the turnup portion 67 intervenes between the capillary valves 71 and 72. The fluid passageway 211C extend from the capillary valve 72 to the mixing chamber 63 to have the capillary valve 72 held in fluid communication with the mixing chamber 63.

This means that the present example of the testing device comprises one fluid passageway constituted by the fluid passageway 211B and one or two other fluid passageways constituted by the fluid passageways 211A and 211C, the fluid passageways 211A, 211B, and 211C are intersected by and held in fluid communication with one another at respective intersecting areas, to have a fluid accommodated in the intersecting area of the fluid passageway 211B mixed and diluted with a fluid flowing at a predetermined direction through the intersecting areas of the fluid passageway 211A and the fluid passageway 211C toward the mixing chamber 63. The fluid passageway 211B is intersected by and held in fluid communication with the fluid passageway 211A at a point constituted by a capillary valve 71 where each of the fluid passageways 211A and 211B is increased in width. The fluid passageway 211B is intersected by and held in fluid communication with the fluid passageway 211C at a point constituted by a capillary valve 72 where each of the fluid passageways 211B and 211C is increased in width.

The present example of the testing device 60 is mounted on and rotated by, for example, the rotating device 700 show in FIG. 6.

The operation of the present example of the testing device 60 according to the present invention and an example of a method of mixing and diluting a hemolyzed blood fluid carried out by the present example of the testing device 60 will be described later with reference to FIG. 8.

In the present example, as the specimen was used a whole blood specimen (to be used for whole blood test), and as the hemolyzed blood fluid was used a solution prepared by, for example, applying 1 g of potassium chloride to 1 ml of blood contained in an Eppendorf tube to be adequately mixed with each other.

70 μl of the whole blood specimen was firstly introduced into the blood separating chamber 61 through the inlet port 64a while, 5 μl of the hemolyzed blood fluid previously prepared was introduced into the hemolyzed blood chamber 62 through the inlet port 64b to have the blood specimen and the hemolyzed blood fluid introduced in the testing device 60 (introducing step, dividing step of dividing blood specimen into a first blood portion to be hemolyzed and a second blood portion to be separated into a blood plasma and blood cells). The whole blood specimen can be introduced into the blood separating chamber 61 with ease because of the fact that the blood separating chamber 61 has formed therein the air opening 113a. The whole blood specimen permeated through the fluid passageway 211A by a capillary action and then came to a stationary state at the capillary valve 122a. Likewise, the hemolyzed blood fluid can be introduced into the hemolyzed blood chamber 62 with ease because of the fact that the hemolyzed blood chamber 62 has a formed therein the air opening 113b. The hemolyzed blood fluid permeated through the fluid passageway 211B by a capillary action and then came to a stationary state at the capillary valve 122b.

The testing device 60 was then rotated by the rotating device 700 at 4000 rpm (rotation per minute) for four minutes. While the testing device 60 was rotated, the blood contained in the blood separating chamber 61 was sufficiently separated into blood cells and blood plasma (blood separating process (blood cell and blood plasma obtaining step)). Further, while the testing device 60 was rotated, the fluid (blood plasma) contained in the blood separating chamber 61 was flowed through the fluid passageway 211A beyond the capillary valve 122a to such an extent that a surface of the fluid contained in the blood separating chamber 61 was approximately equal in a distance from the rotation center of the testing device 60 to a surface of the fluid flowed through the fluid passageway 211A, and the fluid (hemolyzed blood fluid) contained in the hemolyzed blood chamber 62 was flowed through the fluid passageway 211B beyond the capillary valve 122b to such an extent that a surface of the fluid contained in the hemolyzed blood chamber 62 was approximately equal in a distance from the rotation center of the testing device 60 to a surface of the fluid flowed through the fluid passageway 211B.

After the testing device 60 was stopped from being rotated, the blood plasma was further flowed through the fluid passageway 211A to the air opening 66 by a capillary action and the fluid (hemolyzed blood fluid) was further flowed through the fluid passageway 211B to the air opening 69 by a capillary action. On the other hand, the fluid passageway 211A and the fluid passageway 211B were not interfered with each other because of the capillary valves 71 and 72 (blood specimen and blood plasma flowing process after the rotation of the testing device 60 is stopped (fluid flowing step)).

The testing device 60 was continuously rotated by the rotating device 700 for another one minute with the result that the blood plasma contained in the fluid passageway 211A extending to the air opening 66 was flowed beyond the capillary valves 71 and 72 through the fluid passageway 211C into the mixing chamber 63. This caused the hemolyzed blood fluid contained substantially in the turnup portion 67 forming part of the fluid passageway 211B extending to the air opening 69 to be mixed and diluted with the blood plasma flowed through the fluid passageway 211A and the fluid passageway 211C intersecting the fluid passageway 211B and then flowed into the mixing chamber 63. This leads to the fact that the present example of the testing device 60 makes it possible for the hemolyzed blood fluid to be mixed and diluted with the blood plasma at an extremely high dilution ratio, resulting from the fact that the present example of the testing device 60 comprises a specimen fluid passageway constituted by the fluid passageway 211B having a specimen fluid accommodated therein and one or more diluting fluid flowing passageways constituted by the fluid passageways 211A and 211C respectively having diluting fluids flowed therethrough at predetermined directions, and in which the specimen fluid passageway 211B, and the one or more diluting fluid flowing passageways 211A and 211C are intersected with one another at respective intersecting areas to have the specimen fluid accommodated in the intersecting area of the fluid sample passageway 211B mixed and diluted with the diluting fluids flowing through the intersecting areas of the one or more diluting fluid flowing passageways 211A and 211C at the predetermined direction.

Further, in the present example, the dilution ratio can be determined based on a ratio of the amount of the specimen sample held in an area around the passageway merging area, which is the fluid passageway 211A disposed outwardly of the rotation center of the testing device 60 (outwardly of the line L2 from the rotation center of the testing device 60), to the amount of the diluting fluid flowed beyond the capillary valves 71 and 72 through the fluid passageway 211C. This means that the dilution ratio is adjustable on the basis of, for example, the capacity of the fluid passageway 211A disposed outwardly of the rotation center of the testing device 60, the width of the fluid passageways 211A, the distance between the turnup portion 67 and each of the turnup portions 68a and 68b, and the like.

While it has been described in the present example that the fluid passageway 211A, the fluid passageway 211B, and the fluid passageway 211C are disposed spaced apart from one another through spaces constituted by the capillary valves 71 and 72 greater in width than the other neighboring portion of each of the fluid passageways, it is needless to mention that the fluid passageway 211A, the fluid passageway 211B, and the fluid passageway 211C may be disposed spaced apart from one another at a distance long enough to stop fluids from being flowed therethrough by a capillary action, in addition to the capillary valves 71 and 72. The testing device 60 thus constructed can further effectively stop the diluting fluid from being flowed beyond the capillary valves 71 and 72 into the mixing chamber while the testing device 60 is stopped, and thus prevent the dilution precision from being aggravated.

From the foregoing description, it is to be understood that the present example of the testing device can mix and dilute a hemolyzed blood fluid with blood plasma separated from a blood specimen at an extremely high dilution ratio while the present example of the testing device is rotated and stopped from being rotated under predetermined conditions, resulting from the fact that the present example of the testing device and the blood mixing and diluting method can mix and dilute the hemolyzed blood fluid with the blood plasma separated from the whole blood specimen while the present example of the testing device is rotated and stopped from being rotated under predetermined conditions.

### Fifth Example

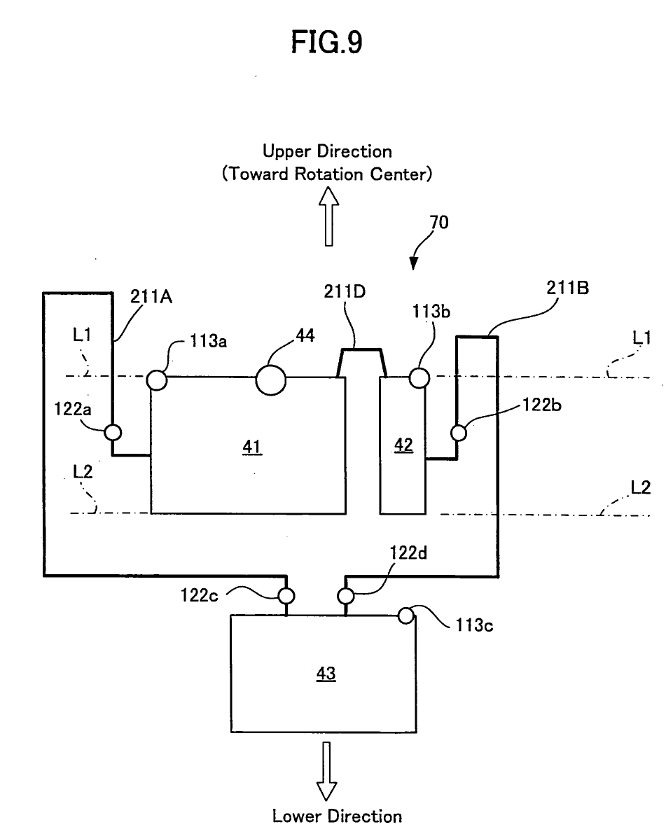

Referring to FIG. 9 of the drawings, there is shown a third example of a testing device according to the present invention. The construction of the present example of the testing device will be firstly described with reference to FIG. 9 and the operation of introducing a specimen sample into the present example of the testing device will be described later. The constituent elements of the present example the same as those of the previous example have respective reference numerals the same as those of the previous example and will thus not be described hereinlater.

As clearly seen from FIG. 9, the present example of the testing device denoted by a reference numeral 70 comprises therein a blood separating chamber 41, a hemolyzed blood chamber 42, and a mixing chamber 43. The testing device 70 is rotatable around a rotation center, not shown in FIG. 9. Similar to the previous example of the testing device, the testing device 70 is produced by adaptively connecting an appropriate number of the first passageway parts 11 and the second passageway parts 12 shown in FIG. 1.

Here, the blood separating chamber 41 has formed therein an air opening 113a, an inlet port 44, a first outlet port, not shown, held in fluid communication with a fluid passageway 211A, and a second outlet port, not shown, held in fluid communication with a fluid passageway 211D. The fluid passageway 211A is formed with a capillary valve 122a in the vicinity of the blood separating chamber 41. The hemolyzed blood chamber 42 has formed therein an air opening 113b, an inlet port, not shown, held in fluid communication with the fluid passageway 211D, and an outlet port, not shown, held in fluid communication with a fluid passageway 211B. The fluid passageway 211B is formed with a capillary valve 122b in the vicinity of the hemolyzed blood chamber 42. The mixing chamber 43 has formed therein an air opening 113c, inlet ports, not shown, respectively held in fluid communication with the fluid passageway 211A and the fluid passageway 211B. The fluid passageway 211A is formed with a capillary valve 122c in the vicinity of the mixing chamber 43. The fluid passageway 211B is formed with a capillary valve 122d in the vicinity of the mixing chamber 43. This means that the fluid passageway 211A has two capillary valves 122a and 122c, and the fluid passageway 211B has two capillary valves 122b and 122d.

Similar to the third example of the testing device 50, the hemolyzed blood chamber 42 has accommodated therein a hemolyzing agent. Further, the hemolyzed blood chamber has accommodated therein a proteolytic enzyme for breaking up hemoglobins contained in the hemolyzed blood fluid. The proteolytic enzyme may be prepared by, for example, applying a solution containing the proteolytic enzyme to an inner surface of the hemolyzed blood chamber 42, and the drying the inner surface of the hemolyzed blood chamber 42.

The blood separating chamber 41 has an upper surface facing toward the rotation center of the testing device 70 and a lower surface opposing to the upper surface. The upper surface of the blood separating chamber 41 is represented by a dotted line L1 passing thereon. The lower surface of the blood separating chamber 41 is represented by a dotted line L2 passing thereon. As will be clearly seen from FIG. 9, the dotted line L1 and the dotted line L2 are illustrated as straight lines for the purpose of simplifying the description and assisting in understanding about the whole operation of the testing device 70. In reality, the upper surface and the lower surface of the blood separating chamber 41 are disposed in concentric relationship with the rotation center of the testing device 70. Therefore, the dotted lines L1 and L2 are circular arcs respectively disposed in concentric relationship with the rotation center of the testing device 70. The fluid passageway 211A extending from the blood separating chamber 41 to a passageway merging area constituted by the mixing chamber 43, includes an upper fluid passageway portion positioned inwardly of the upper surface of the blood separating chamber 41 toward the rotation center of the testing device 70 (inwardly of the line L1 toward the rotation center of the testing device 70), and a lower fluid passageway portion positioned outwardly of the lower surface of the blood separating chamber 41 from the rotation center of the testing device 70 (outwardly of the line L2 from the rotation center of the testing device 70). Likewise, the fluid passageway 211B extending from the hemolyzed blood chamber 42 to the mixing chamber 43 includes an upper fluid passageway portion positioned inwardly of the upper surface of the blood separating chamber 41 toward the rotation center of the testing device 70 (inwardly of the line L1 toward the rotation center of the testing device 70), and a lower fluid passageway portion positioned outwardly of the lower surface of the blood separating chamber 41 from the rotation center of the testing device 70 (outwardly of the line L2 from the rotation center of the testing device 70).

The blood separating chamber 41 is held in fluid communication with the hemolyzed blood chamber 42 through the fluid passageway 211D extending from the blood separating chamber 41 to the hemolyzed blood chamber 42 and disposed inwardly of the upper surface of the blood separating chamber 41 and an upper surface of the hemolyzed blood chamber 42 toward the rotation center of the testing device 70 as clearly seen from FIG. 9. The present example of the testing device 70 thus constructed ensures that the specimen sample introduced into the blood separating chamber 41 through the inlet port 44 is flowed through the fluid passageway 211D to the hemolyzed blood chamber 42 when the blood separating chamber 41 is approximately filled with the specimen sample, thereby making it possible for the specimen sample introduced through the single inlet port 44 to flow into two or more chambers, viz., the blood separating chamber 41 and the hemolyzed blood chamber 42.

From the foregoing description, it is to be understood that the present example of the testing device 70 according to the present invention makes it possible for the specimen sample introduced through the single inlet port 44 to be distributed to a plurality of chambers, viz., the blood separating chamber 41 and the hemolyzed blood chamber 42 respectively by predetermined amounts, thereby further expanding the applicable scope of the testing device, resulting from the fact that the present example of the testing device 70 thus constructed ensures that the specimen sample introduced into the blood separating chamber 41 through the single inlet port 44 is flowed through fluid passageway 211d to the hemolyzed blood chamber 42 and even other chambers when the blood separating chamber 41 is approximately filled with the specimen sample. Further, the present example of the testing device 70 is excellent in operability, resulting from the fact that the present example of the testing device 70 thus constructed ensures that the specimen sample introduced into the testing device 70 through the single inlet port 44 is flowed to a plurality of chambers, viz., the blood separating chamber 41 and the hemolyzed blood chamber 42. In addition, the hemolyzed blood chamber 42 may have accommodated therein a denaturing agent in a freeze-dry state. The hemolyzed blood chamber 42 having accommodated therein the denaturing agent can denature hemoglobins contained in the blood specimen introduced thereinto.

From the foregoing description, it is to be understood that the previous examples of the testing device according to the present invention can mix and dilute a hemolyzed blood fluid with blood plasma separated and obtained from blood specimen introduced therein while the testing device is rotated and stopped from being rotated. The testing device thus constructed can eliminate preparation processes of diluting a hemolyzed blood at a predetermined dilution ratio, which is essential to the conventional testing device, thereby further eliminating the need of agents such as, for example, a buffer fluid, and the like, required for the preparation processes. The fact that the testing device according to the present invention is not required to introduce the additional buffer fluid thereinto. This leads to the fact that the testing device according to the present invention can obtain further advantage of making it possible for the specimen sample only once introduced into the testing device according to the present invention to be used for a plurality of tests at the same time, because of the fact that, a specimen, for example, the blood plasma separated from the blood specimen is not diluted with the additional buffer fluid. The testing device according to the present invention is useful as a testing device and a method of mixing and diluting a blood using the testing device to be applied in the field of clinical examination, especially in the field of the POCT.

### Sixth Example

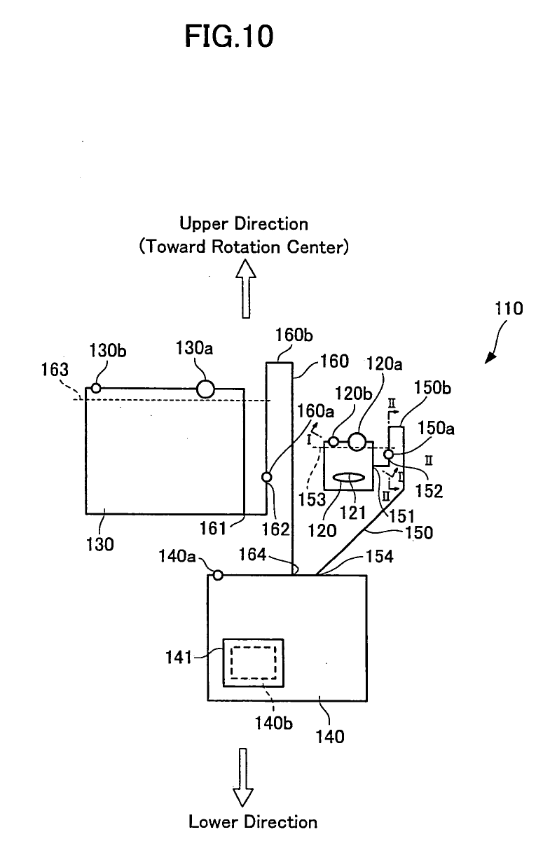

Referring now to FIG. 10 of the drawings, there is shown a sixth example of a testing device according to the present invention. FIG. 10 is a schematic top elevational view of the present example of the testing device according to the present invention.

The construction of the present example of the testing device will be firstly described with reference to FIG. 10.

As clearly seen from FIG. 10, the present example of the testing device denoted by a reference numeral 110 comprises therein a blood separating chamber 120 for having a blood specimen hemolyzed and separated into blood cells and blood plasma therein, a diluting fluid inlet chamber 130 having accommodated therein a diluting fluid for diluting components forming part of the blood specimen, and a mixing chamber 140 for having the blood specimen mixed and diluted with the diluting fluid, a fluid passageway 150 having a first end held in fluid communication with the blood separating chamber 120 and a second end held in fluid communication with the mixing chamber 140 to have the blood separating chamber 120 and the mixing chamber 140 held in fluid communication with each other, and a fluid passageway 160 having a first end held in fluid communication with the diluting fluid inlet chamber 130 and a second end held in fluid communication with the mixing chamber 140 to have the diluting fluid inlet chamber 130 and the mixing chamber 140 held in fluid communication with each other.

The testing device 110 is rotatable around a rotation center, not shown in FIG. 10. As described in the above, the testing device 110 is produced by adaptively connecting an appropriate number of the first passageway parts 11 and the second passageway parts 12 shown in FIG. 1.

The blood separating chamber 120 has formed therein an inlet port 120a for introducing a blood specimen therethrough, an air opening 120b, and an outlet port, not shown, held in fluid communication with the fluid passageway 150. The blood separating chamber 120 has accommodated therein, for example, potassium chloride as a hemolyzing agent. Though it has been described in the present example that potassium chloride is used as the hemolyzing agent, according to the present invention as the hemolyzing agent may be used any other composition such as, for example, a surface acting agent, salt, and the like, as long as the composition has an effect of destroying the erythrocyte membranes while osmotic pressure exerted on each of erythrocyte membranes is changed.

In order to reduce the concentration of hemoglobins contained in a hemolyzed blood fluid, i.e., a blood plasma fluid, it is preferable to create a state where a certain amount of erythrocytes remains undestroyed in the blood plasma fluid. To hemolyze a blood specimen with an amount of the hemolyzing agent less than that of the hemolyzing agent required to hemolyze whole of the blood specimen will be hereinlater referred to as “partial hemolysis” or “partially hemolyze a blood specimen”. The blood plasma fluid obtained after the blood specimen is partially hemolyzed will be hereinlater referred to as a “partially hemolyzed blood plasma fluid”.

In the present example, the amount of potassium chloride 121 accommodated in the blood separating chamber 120 is 800 μg, which is equivalent to 1% weight/volume in 80 μl of blood. 1% weight/volume of potassium chloride 121 is capable of partially hemolyzing a blood specimen at 1.6% (in the case that the blood specimen contains 15 g/dl of hemoglobins, 0.24 g/dl of hemoglobins can be eluted out of the partial hemolysis). The blood separating chamber 120 has a volume capable of having accommodated therein 10 μl of blood.

The diluting fluid inlet chamber 130 has formed therein an inlet port 130a for introducing a diluting fluid therethrough, an air opening 130b, and an outlet port, not shown, held in fluid communication with a fluid passageway 160. The diluting fluid inlet chamber 130 has a volume capable of having introduced therein 80 μl of the diluting fluid.

The mixing chamber 140 has formed therein an air opening 140a, inlet ports, not shown, respectively held in fluid communication with the fluid passageway 150 and the fluid passageway 160, an outlet port 140b for allowing the mixed fluid to be collected out of the testing device 110. The outlet port 140b forming part of the mixing chamber 140 is closed with an adhesive tape 141. The mixing chamber 140 has a volume capable of having introduced therein equal to or more than 83 μl of a fluid.

The fluid passageway 150 is formed with a capillary valve 150a in the vicinity of the blood separating chamber 120. The capillary valve 150a defines an area in the fluid passageway 150 greater in width (cross-sectional area) than the other neighboring portions of the fluid passageway 150. The fluid passageway 150 includes a passageway portion 150b in the form of an inverted U shape having a turnup portion disposed inwardly of the blood separating chamber 120 toward the rotation center of the testing device 110. The inverted U-shaped passageway portion 150b is disposed between the capillary valve 150a and the mixing chamber 140. The width (cross-sectional area) of the fluid passageway 150 except the capillary valve 150a is small enough to allow a capillary action to take place.

While the testing device 110 is rotated, the blood specimen accommodated in the blood separating chamber 120 is flowed through the fluid passageway 150 beyond the capillary valve 150a by a centrifugal force and siphon effect. The blood separating chamber 120 is held in fluid communication with the first end of the fluid passageway 150 at a boundary point denoted by a reference numeral 151 spaced apart at a predetermined distance from the rotation center of the testing device 110 so that the fluid contained in the blood separating chamber 120 is flowed through the fluid passageway 150 out of the blood separating chamber 120 to have 7 μl of the fluid remained in the blood separating chamber 120 while the testing device 110 is rotated.

The fluid passageway 160 is formed with a capillary valve 160a in the vicinity of the diluting fluid inlet chamber 130. The capillary valve 160a defines an area in the fluid passageway 160 greater in width (cross-sectional area) than the other neighboring portions of the fluid passageway 160. The fluid passageway 160 includes a passageway portion 160b in the form of an inverted U shape having a turnup portion disposed inwardly of the diluting fluid inlet chamber 130 toward the rotation center of the testing device 110. The inverted U-shaped passageway portion 160b is disposed between the capillary valve 160a and the mixing chamber 140. The width (cross-sectional area) of the fluid passageway 160 except the capillary valve 160a is small enough to allow a capillary action to take place.

While the testing device 110 is rotated, the diluting fluid accommodated in the diluting fluid inlet chamber 130 is flowed through the fluid passageway 160 beyond the capillary valve 160a by a centrifugal force and siphon effect. The diluting fluid inlet chamber 130 is held in fluid communication with the first end of the fluid passageway 160 at a boundary point designated by a reference numeral 161 spaced apart at a predetermined distance from the rotation center of the testing device 110 so that all of the diluting fluid contained in the diluting fluid inlet chamber 130 is flowed through the fluid passageway 160 out of the diluting fluid inlet chamber 130 while the testing device 110 is rotated.

The operation of mixing and diluting hemolyzed blood fluid, viz., hemoglobins, with a diluting fluid carried out by the present example of the testing device 110 according to the present invention will be described hereinlater.

In the present example, as the specimen was used a whole blood specimen (to be used for whole blood test), and as the diluting fluid was used a 1% sodium dodecyl sulfate (hereinlater referred to simply as “SDS”) solution.

10 μl of the whole blood specimen was firstly introduced into the blood separating chamber 120 through the inlet port 120a. The whole blood specimen can be introduced into the blood separating chamber 120 with ease because of the fact that the blood separating chamber 120 has formed therein the air opening 120b. The whole blood specimen permeated through the fluid passageway 150 by a capillary action and then came to a stationary state at a point denoted by a reference numeral 152 stopped short of the capillary valve 150a. Likewise, 80 μl of the 1% SDS solution was introduced into the diluting fluid inlet chamber 130 through the inlet port 130a. The 1% SDS solution can be introduced into the diluting fluid inlet chamber 130 with ease because of the fact that the diluting fluid inlet chamber 130 has formed therein the air opening 130b. The 1% SDS solution permeated through the fluid passageway 160 by a capillary action and came to a stationary state at a point denoted by a reference number 162 stopped short of the capillary valve 160a. The 1% SDS solution was a reagent of Hemoglobin Test Wako (commercially available from Wako Pure Chemical Industries, Ltd.) for denaturing and oxidizing hemoglobin to make the hemoglobin stabilized in terms of its absorption characteristics.

The testing device 110 was then mounted on the turntable 713 of the rotating device 700 shown in FIG. 6. The control unit 715 was operated to control the spindle motor 714 to have spindle motor 714 rotate the testing device 110 together with the turntable 713. The testing device 110 was thus rotated by the rotating device 700 at 4000 rpm (rotation per minute) for four minutes.

During the first rotation of the testing device 110, the whole blood specimen contained in the testing device 110 was held in the blood separating chamber 120 and the fluid passageway 150 by a centrifugal force to such an extent that a surface of the whole blood specimen contained in the blood separating chamber 120 and that of the whole blood specimen contained in the fluid passageway 150 were aligned with a dotted line denoted by a reference numeral 153 as clearly shown in FIG. 10. This means that the whole blood specimen was flowed through the fluid passageway 150 beyond the capillary valve 150a toward the mixing chamber 140 and came to the line 153 stopped short of the inverted U-shaped passageway portion 150b. As will be clearly seen from FIG. 10, the dotted line 153 is illustrated as a straight line for the purpose of simplifying the description and assisting in understanding about the whole operation of the testing device 110. In reality, the surface of the whole blood specimen contained in the blood separating chamber 120 and that of the whole blood specimen contained in the fluid passageway 150 are disposed in concentric relationship with the rotation center of the testing device 110. Therefore, the dotted line 153 is a circular arc disposed in concentric relationship with the rotation center of the testing device 110. In addition, during the first rotation of the testing device 110, the whole blood specimen contained in the blood separating chamber 120 was partially hemolyzed with the potassium chloride 121 accommodated in the blood separating chamber 120 and separated into blood cells and blood plasma.

Further, during the first rotation of the testing device 110, the 1% SDS solution contained in the testing device 110 was held in the diluting fluid inlet chamber 130 and the fluid passageway 160 by a centrifugal force to such an extent that a surface of the 1% SDS solution contained in the diluting fluid inlet chamber 130 and that of the 1% SDS solution contained in the fluid passageway 160 were aligned with a dotted line denoted by a reference numeral 163 as clearly shown in FIG. 10. This means that the 1% SDS solution was flowed through the fluid passageway 160 beyond the capillary valve 160a toward the mixing chamber 140 and came to the line 163 stopped short of the inverted U-shaped passageway portion 160b. As will be clearly seen from FIG. 10, the dotted line 163 is illustrated as a straight line for the purpose of simplifying the description and assisting in understanding about the whole operation of the testing device 110. In reality, the surface of the 1% SDS solution contained in the diluting fluid inlet chamber 130 and that of the 1% SDS solution contained in the fluid passageway 160 are disposed in concentric relationship with the rotation center of the testing device 110. Therefore, the dotted line 163 is a circular arc disposed in concentric relationship with the rotation center of the testing device 110.

The control unit 715 was then operated to control the spindle motor 714 to have spindle motor 714 stop from rotating the testing device 110 together with the turntable 713. The testing device 110 was thus stopped from being rotated.

After the testing device 110 was stopped from being rotated, the blood plasma of the partially hemolyzed blood, hereinlater simply referred to as “partially hemolyzed blood plasma fluid”, was further flowed through the fluid passageway 150 beyond the inverted U-shaped passageway portion 150b and came to a boundary point denoted by 154 between the fluid passageway 150 and the mixing chamber 140 by a capillary action. The partially hemolyzed blood plasma fluid can be flowed through the fluid passageway 150 with ease by the capillary action because of the fact that the mixing chamber 140 has formed therein the air opening 140a. Likewise, after the testing device 110 was stopped from being rotated, the 1% SDS solution was further flowed through the fluid passageway 160 beyond the inverted U-shaped passageway portion 160b and came to a boundary point denoted by 164 between the fluid passageway 160 and the mixing chamber 140 by a capillary action. The 1% SDS solution can be flowed through the fluid passageway 160 with ease by the capillary action because of the fact that the mixing chamber 140 has formed therein the air opening 140a.

The testing device 110 was again rotated by the rotating device 700 at 1500 rpm (rotation per minute) for one minute.

During the second rotation of the testing device 110, the partially hemolyzed blood plasma fluid accommodated in the blood separating chamber 120 was flowed from the blood separating chamber 120 through the fluid passageway 150 into the mixing chamber 140 by the centrifugal force and siphon effect. As described hereinearlier, the blood separating chamber 120 is held in fluid communication with the first end of the fluid passageway 150 at the boundary point 151 spaced apart at the predetermined distance from the rotation center of the testing device 110 so that the fluid contained in the blood separating chamber 120 is flowed through the fluid passageway 150 out of the blood separating chamber 120 to have 7 μl of the fluid remained in the blood separating chamber 120 while the testing device 110 is rotated. The fact that 10 μl of the whole blood specimen had been introduced into the blood separating chamber 120 leads to the fact that approximately 3 μl of the partially hemolyzed blood plasma was introduced into the mixing chamber 140 through the fluid passageway 150.

Further, during the second rotation of the testing device 110, the 1% SDS solution contained in the testing device 110 was flowed from the diluting fluid inlet chamber 130 through the fluid passageway 160 into the mixing chamber 140 by centrifugal force and siphon effect. As described hereinearlier, the diluting fluid inlet chamber 130 is held in fluid communication with the first end of the fluid passageway 160 at the boundary point 161 spaced apart at the predetermined distance from the rotation center of the testing device 110 so that all of the diluting fluid contained in the diluting fluid inlet chamber 130 is flowed through the fluid passageway 160 out of the diluting fluid inlet chamber 130 while the testing device 110 is rotated. The fact that 80 μl of the 1% SDS solution had been introduced into the diluting fluid inlet chamber 130 leads to the fact that approximately 80 μl of the 1% SDS solution was introduced into the mixing chamber 140 through the fluid passageway 160.

The control unit 715 was then operated to control the spindle motor 714 to have spindle motor 714 stop from rotating the testing device 110 together with the turntable 713. The testing device 110 was thus stopped from being rotated. The partially hemolyzed blood plasma fluid and the 1% SDS solution were thus mixed with each other in the mixing chamber 140 and a diluted fluid was obtained.

The adhesive tape 141 was removed from the outlet port 140b forming part of the mixing chamber 140, and a required amount of the diluted fluid was collected by, for example, a glass tube and a pipette from the mixing chamber 140 through the outlet port 140b.

In the mixing chamber 140, approximately 3 μl of the partially hemolyzed blood plasma was mixed and diluted with approximately 80 μl of the 1% SDS solution at a dilution ratio of 28. In the present example, 1.6% of the partially hemolyzed blood fluid had been introduced into the blood separating chamber 120. This means that the hemolyzed blood fluid had already been diluted at a dilution ratio of 62.5. This leads to the fact that the present example of the testing device 110 makes it possible for the hemolyzed blood fluid to be diluted at a dilution ratio of approximately 1750.

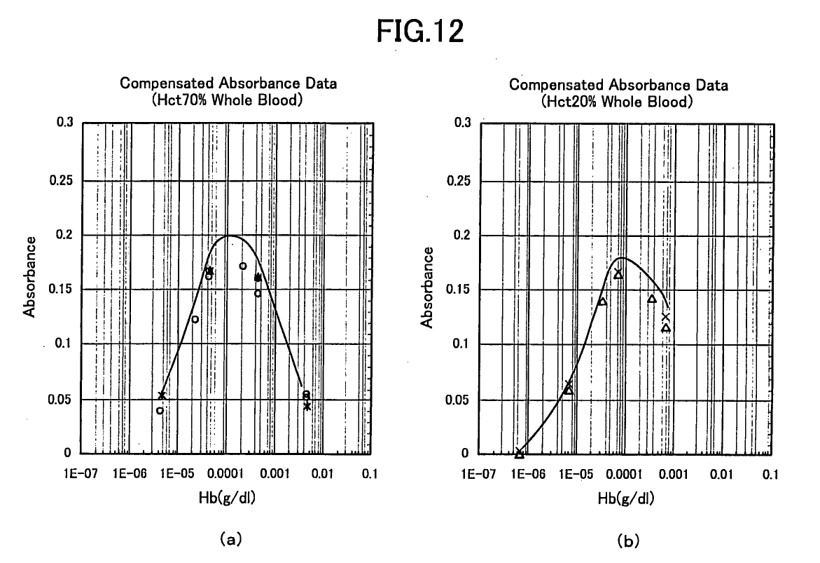

A hemoglobin concentration can be calculated using a standard curve shown in FIG. 11 or FIG. 12. FIG. 11 is a graph showing an analytical standard curve for an SLS (Sodium Dodecyl Sulfate)-Hb (Hemoglobin) method applicable to a Hemoglobin Test WAKO (a hemoglobin measuring kit commercially available from Wako Pure Chemical Industries, Ltd.). The standard curve shown in FIG. 11 was made in the following manner. Firstly, a plurality of hemoglobin standard solutions (1 μl each) different from one another in dilution ratio were added to respective 1% SLS solutions (4 ml each), and mixed well to prepare hemoglobin control solutions. Secondly, absorbance was measured at a wavelength of 540 nm for each of the hemoglobin control solutions thus prepared to obtain measured values. Using the measured values, the standard curve for absorbance (at a wavelength of 540 nm) with respect to hemoglobin concentration was made. Similarly, the standard curve shown in FIG. 12 was made in the following manner. Firstly, a plurality of hemoglobin standard solutions (27 μl each) different from one another in dilution ratio were added to respective mixture solutions each composed of buffer fluid (590 μl) and a latex-labeled hemoglobin antibody fluid (50 μl), and mixed well to prepare hemoglobin control solutions. Secondly, absorbance was measured at a wavelength of 660 nm for each of the hemoglobin control solutions thus prepared to obtain measured values. In the present example, the standard curve shown in FIG. 12 was made using a latex immunoagglutination measuring kit with Extel Hemo Auto latex immunoagglutination reagent commercially available from Kyowa-medex Corp. Using the standard curves shown in FIG. 11 and FIG. 12, hemoglobin concentration was calculated for each of the specimens. For example, the specimen having a high concentration of hemoglobin should be calculated using, preferably, the SLS-Hb method with reference to the standard curve shown in FIG. 11. On the other hand, the specimen having a low concentration should be calculated using, preferably, the latex immunoagglutination method with reference to the standard curve shown in FIG. 12. The specimen to be measured with reference to FIG. 12 is required to be in advance diluted as appropriate because of the fact that the standard curve shown in FIG. 12 is made for the purpose of carrying out ultrasensitive measurement.

From the foregoing description, it is to be understood that the present example of the testing device 110 can, with ease, carry out preprocesses such as, for example, a blood separating process, a hemolyzing process, and a diluting process within the present example of the testing device 110 while the present example of the testing device 110 is rotated and stopped from being rotated under predetermined conditions, resulting from the fact that the present example of the testing device 110 has accommodated therein a blood specimen and a diluting fluid. This leads to the fact that the present example of the testing device 110 is excellent in operability and does not cause any waste. In addition, the fact that the present example of the testing device 110 does not cause any waste leads to the fact that the present example of the testing device 110 is friendly to users and the environment.

Further, in order to dilute, for example, 111 of a blood specimen at a dilution ratio of, for example, 1750 in the conventional diluting method, 1.75 ml of a diluting fluid is required, thereby making it impossible for the conventional small-type testing device to dilute even a minute amount of the blood specimen with a single process. On the contrary, the present example of the testing device 110 can dilute a blood specimen at a dilution ratio of 1750 with a quite small amount, viz., 80 μl of a diluting fluid, thereby making it possible for the present example of the testing device 110 to dilute the blood specimen with a single process. This leads to the fact that the present example of the testing device 110 is excellent in operability and can be made small in size, as well as cause no waste.

In addition, the present example of the testing device 110 has a volume capable of having introduced therein equal to or more than 80 μl of the diluting fluid, which is large enough in amount to dilute the required amount of the blood specimen accommodated therein, thereby making it possible for the present example of the testing device 110 to prevent the diluting fluid from overflowing therefrom.

Further, the present example of the testing device 110 has accommodated therein potassium chloride 121 of 800 μg, which is not enough in amount to hemolyze the whole mount, viz., 10 μl of the blood specimen accommodated in the blood separating chamber 120. This means that the present example of the testing device 110 has accommodated therein potassium chloride 121 small enough in amount to partially hemolyze the blood specimen accommodated in the blood separating chamber 120, and thus lessen an amount of hemolyzed blood fluid to be made, thereby reducing the amount of the diluting fluid required to be introduced therein.

Yet further, the present example of the testing device 110 has accommodated therein potassium chloride 121 of 800 μg, which is small enough in amount to partially hemolyze the blood specimen accommodated in the blood separating chamber 120 to such an extent that the hemoglobin concentration in the mixed and diluted blood plasma fluid contained in the mixing chamber 140 is diluted at a dilution ratio of equal to or more than 250. This leads to the fact that the present example of the testing device 110 makes it possible for the mixed and diluted fluid obtained from the mixing chamber 140 to be quantified directly by a colorimetric method. In addition, the present example of the testing device 110 has accommodated therein potassium chloride 121 of 800 μg, which is small enough in amount to partially hemolyze the blood specimen accommodated in the blood separating chamber 120 to such an extent that the hemoglobin concentration in the mixed and diluted blood plasma fluid contained in the mixing chamber 140 is diluted at a dilution ratio of equal to or more than 500. This leads to the fact that the present example of the testing device 110 makes it possible for the mixed and diluted fluid obtained from the mixing chamber 140 to be quantified directly by a competitive immunoassay method.

Yet further, the present example of the testing device 110 has a plurality of openings formed with fluid passageways and chambers. This leads to the fact that the present example of the testing device 110 enables the fluids to smoothly flow through the fluid passageways and the chambers, thereby making it easier for the fluids to flow between the chambers.

The present example of the testing device 110 comprises a fluid passageway 150 having a passageway portion 150b in the form of an inverted U shape having a turnup portion disposed inwardly of the blood separating chamber 120 toward the rotation center of the testing device 110 to have a partially hemolyzed blood fluid flowed through the fluid passageway 150 by a capillary action. This leads to the fact that the present example of the testing device 110 can have the partially hemolyzed blood fluid held in the blood separating chamber 120 while the testing device 110 itself is being rotated. On the other hand, the present example of the testing device 110 can have the partially hemolyzed blood fluid flowed through the fluid passageway 150 from the blood separating chamber 120 when the testing device 110 is stopped from being rotated and the partially hemolyzed blood fluid is released from the centrifugal force.

Further, the present example of the testing device 110 comprises a fluid passageway 160 having a passageway portion 160b in the form of an inverted U shape having a turnup portion disposed inwardly of the diluting fluid inlet chamber 130 toward the rotation center of the testing device 110 to have a diluting fluid flowed through the fluid passageway 160 by a capillary action. This leads to the fact that the present example of the testing device 110 can have the diluting fluid held in the diluting fluid inlet chamber 130 while the testing device 110 itself is being rotated. On the other hand, the present example of the testing device 110 can have the diluting fluid flowed through the fluid passageway 160 from the diluting fluid inlet chamber 130 when the testing device 110 is stopped from being rotated and the diluting fluid is released from the centrifugal force.

As described in the above that in the present example of the testing device 110, the hemolyzed blood fluid can be diluted at a high dilution ratio by adjusting the amount of the hemolyzing agent to be introduced into the testing device 110. In order to dilute the hemolyzed blood fluid at a far higher dilution ratio of, for example, 5000, the present example of the testing device 110 requires 0.6% of the partially hemolyzed blood fluid, thereby aggravating the dilution precision. The present example of the testing device 110 according to the present invention may be replaced by a seventh example of the testing device according to the present invention in order to attain the objects of the present invention in the case that the dilution ratio is extremely high. The following description will be directed to the seventh example of the testing device according to the present invention.

### Seventh Example

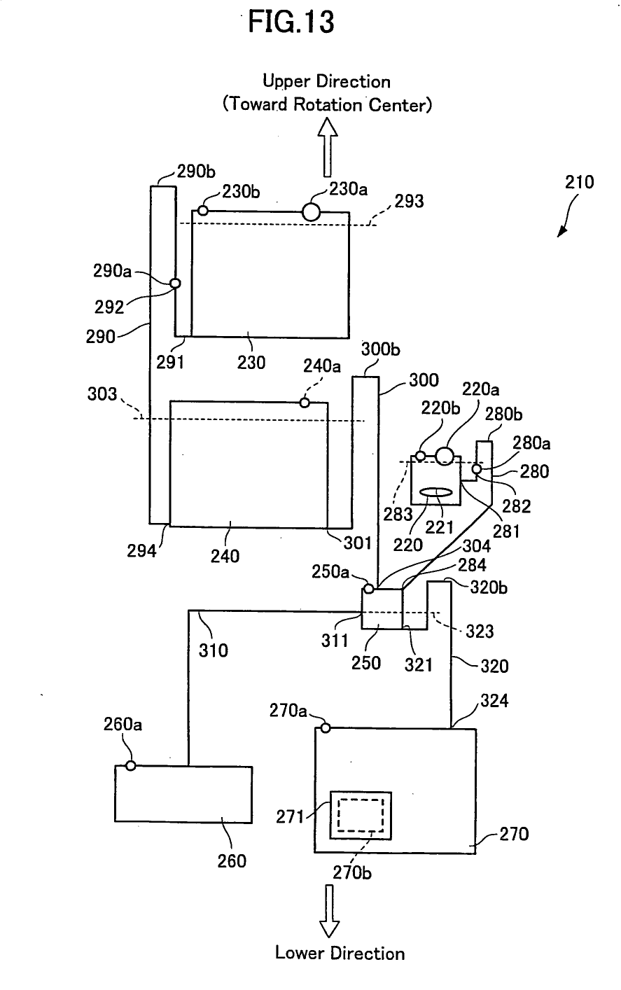

Referring now to FIG. 13 of the drawings, there is shown a seventh example of a testing device according to the present invention. FIG. 13 is a schematic top elevational view of the present example of the testing device according to the present invention. The present example of the testing device is designed to dilute hemoglobins contained in erythrocytes forming part of the blood specimen at approximately 5000.

The construction of the present example of the testing device will be firstly described with reference to FIG. 13.

As clearly seen from FIG. 13, present example of the testing device denoted by a reference numeral 210 comprises therein a blood separating chamber 220 for having a blood specimen partially hemolyzed and separated into blood cells and blood plasma therein, a diluting fluid inlet chamber 230 having introduced therein a diluting fluid for diluting hemoglobins contained in erythrocytes forming part of the blood specimen, a synchronizing chamber 240 for synchronizing the flow of the diluting fluid with that of the partially hemolyzed blood fluid during a diluting process of diluting hemoglobins, a blood plasma fluid sampling chamber 250 for sampling a predetermined amount, for example, 1 μl of the partially hemolyzed blood plasma fluid flowed from the blood separating chamber 220, an overflow chamber 260 for having accommodated therein a fluid overflowed from the blood plasma fluid sampling chamber 250, and a mixing chamber 270 having the partially hemolyzed blood fluid mixed and diluted with the diluting fluid therein. The present example of the testing device 210 further comprises, a fluid passageway 280 having a first end held in fluid communication with the blood separating chamber 220 and a second end held in fluid communication with the blood plasma fluid sampling chamber 250 to have the blood separating chamber 220 and the blood plasma fluid sampling chamber 250 held in fluid communication with each other, a fluid passageway 290 having a first end held in fluid communication with the diluting fluid inlet chamber 230 and a second end held in fluid communication with the synchronizing chamber 240 to have the diluting fluid inlet chamber 230 and the synchronizing chamber 240 held in fluid communication with each other, a fluid passageway 300 having a first end held in fluid communication with the synchronizing chamber 240 and a second end held in fluid communication with the blood plasma fluid sampling chamber 250 to have the synchronizing chamber 240 and the blood plasma fluid sampling chamber 250 held in fluid communication with each other, a fluid passageway 310 having a first end held in fluid communication with the blood plasma fluid sampling chamber 250 and a second end held in fluid communication with the overflow chamber 260 to have the blood fluid sampling chamber 250 and the overflow chamber 260 held in fluid communication with each other, and a fluid passageway 320 having a first end held in fluid communication with the blood plasma fluid sampling chamber 250 and a second end held in fluid communication with the mixing chamber 270 to have the blood plasma fluid sampling chamber 250 and the mixing chamber 270 held in fluid communication with each other.

The testing device 210 is rotatable around a rotation center, not shown in FIG. 13. As described in the above, the testing device 210 is produced by adaptively connecting an appropriate number of the first passageway parts 11 and the second passageway parts 12 shown in FIG. 1.

The blood separating chamber 220 has formed therein an inlet port 220a for introducing a blood specimen therethrough, an air opening 220b, and an outlet port, not shown, held in fluid communication with the fluid passageway 280. The blood separating chamber 220 has accommodated therein, for example, potassium chloride 221 as a hemolyzing agent. Though it has been described in the present example that as the hemolyzing agent is used potassium chloride 221, as the hemolyzing agent may be used any other composition such as, for example, a surface acting agent, salt, and the like, as long as the composition has an effect of destroying the erythrocyte membranes while osmotic pressure exerted on each of erythrocyte membranes is changed.

In the present example, the amount of potassium chloride 221 accommodated in the blood separating chamber 220 is 800 μg, which is equivalent to 1% weight/volume in 80 μl of blood. 1% weight/volume of potassium chloride 221 is capable of partially hemolyzing a blood specimen at 1.6% (in the case that the blood specimen contains 15 g/dl of hemoglobins, 0.24 g/dl of hemoglobins can be eluted out of the partial hemolysis). The blood separating chamber 220 has a volume capable of having accommodated therein 10 μl of blood.

The diluting fluid inlet chamber 230 has formed therein an inlet port 230a for introducing a diluting fluid therethrough, an air opening 230b, and an outlet port, not shown, held in fluid communication with a fluid passageway 290. The diluting fluid inlet chamber 230 has a volume capable of having introduced therein 80 μl of the diluting fluid.

The synchronizing chamber 240 has formed therein an inlet port, not shown, held in fluid communication with the fluid passageway 290, an outlet port, not shown, held in fluid communication with the fluid passageway 300, and an air opening 240a. The synchronizing chamber 240 has a volume capable of having introduced therein 80 μl of the diluting fluid.

The blood plasma fluid sampling chamber 250 has formed therein a first inlet port, not shown, held in fluid communication with the fluid passageway 300, a second inlet port, not show, held in fluid communication with the fluid passageway 280, an outlet port, not shown, held in fluid communication with the fluid passageway 320, and an air opening 250a. The blood plasma fluid sampling chamber 250 has a volume capable of having introduced therein equal to or more than 1 μl of a fluid.

The overflow chamber 260 has an inlet port, not shown, held in fluid communication with the fluid passageway 310, and an air opening 260a. The overflow chamber 260 has a volume capable of having introduced therein equal to or more than 2 μl of the partially hemolyzed blood plasma fluid.

The mixing chamber 270 has formed therein an air opening 270a, an inlet port, not shown, held in fluid communication with the fluid passageway 320, and an outlet port 270b for allowing the mixed fluid to be collected out of the testing device 210. The outlet port 270b forming part of the mixing chamber 270 is closed with an adhesive tape 271. The mixing chamber 270 has a volume capable of having introduced therein equal to or more than 81 μl of a fluid.

The fluid passageway 280 is formed with a capillary valve 280a in the vicinity of the blood separating chamber 220. The capillary valve 280a defines an area in the fluid passageway 280 greater in width (cross-sectional area) than the other neighboring portions of the fluid passageway 280. The fluid passageway 280 includes a passageway portion 280b in the form of an inverted U shape having a turnup portion disposed inwardly of the blood separating chamber 220 toward the rotation center of the testing device 210. The inverted U-shaped passageway portion 280b is disposed between the capillary valve 280a and the mixing chamber 270. The width (cross-sectional area) of the fluid passageway 280 except the capillary valve 280a is small enough to allow a capillary action to take place.

While the testing device 210 is rotated, a centrifugal force is exerted on a fluid accommodated in the blood separating chamber 220 to have the fluid flow out of the blood separating chamber 220 through the fluid passageway 280. The blood separating chamber 220 is held in fluid communication with the first end of the fluid passageway 280 at a boundary point denoted by a reference numeral 281 spaced apart at a predetermined distance from the rotation center of the testing device 210 so that the fluid contained in the blood separating chamber 220 is flowed out of the blood separating chamber 220 through the fluid passageway 280 by the centrifugal force and siphon effect to have 7 μl of the fluid remained in the blood separating chamber 220 while the testing device 210 is rotated.

The fluid passageway 290 is formed with a capillary valve 290a in the vicinity of the diluting fluid inlet chamber 230. The capillary valve 290a defines an area in the fluid passageway 290 greater in width (cross-sectional area) than the other neighboring portions of the fluid passageway 290. The fluid passageway 290 includes a passageway portion 290b in the form of an inverted U shape having a turnup portion disposed inwardly of the diluting fluid inlet chamber 230 toward the rotation center of the testing device 210. The inverted U-shaped passageway portion 290b is disposed between the capillary valve 290a and the synchronizing chamber 240. The width (cross-sectional area) of the fluid passageway 290 except the capillary valve 290a is small enough to allow a capillary action to take place.

While the testing device 210 is rotated, a centrifugal force is exerted on a fluid accommodated in the diluting fluid inlet chamber 230 to have the fluid flow out of the diluting fluid inlet chamber 230 through the fluid passageway 290. The diluting fluid inlet chamber 230 is held in fluid communication with the first end of the fluid passageway 290 at a boundary point designated by a reference numeral 291 spaced apart at a predetermined distance from the rotation center of the testing device 210 so that all of the diluting fluid contained in the diluting fluid inlet chamber 230 is flowed out of the diluting fluid inlet chamber 230 through the fluid passageway 290 by the centrifugal force and siphon effect while the testing device 210 is rotated.

The fluid passageway 300 includes a passageway portion 300b in the form of an inverted U shape having a turnup portion disposed inwardly of the synchronizing chamber 240 toward the rotation center of the testing device 210. The width (cross-sectional area) of the fluid passageway 300 is small enough to allow a capillary action to take place.

While the testing device 210 is rotated, a centrifugal force is exerted on a fluid accommodated in the synchronizing chamber 240 to have the fluid flow out of the synchronizing chamber 240 through the fluid passageway 300. The synchronizing chamber 240 is held in fluid communication with the first end of the fluid passageway 300 at a boundary point denoted by a reference numeral 301 spaced apart at a predetermined distance from the rotation center of the testing device 210 so that all of the fluid contained in the synchronizing chamber 240 is flowed out of the synchronizing chamber 240 through the fluid passageway 300 by the centrifugal force and siphon effect while the testing device 210 is rotated.

The fluid passageway 310 extends from the blood plasma fluid sampling chamber 250 to the overflow chamber 260. The width (cross-sectional area) of the fluid passageway 310 is small enough to allow a capillary action to take place.

While the testing device 210 is rotated, a centrifugal force is exerted on a fluid accommodated in the blood plasma fluid sampling chamber 250 to have the fluid flow out of the blood plasma fluid sampling chamber 250 through the fluid passageway 310. The blood plasma fluid sampling chamber 250 is held in fluid communication with the first end of the fluid passageway 310 at a boundary point denoted by a reference numeral 311 spaced apart at a predetermined distance from the rotation center of the testing device 210 so that the fluid contained in the blood plasma fluid sampling chamber 250 is flowed out of the blood plasma fluid sampling chamber 250 through the fluid passageway 310 by the centrifugal force and siphon effect to have 1 μl of the fluid remained in the blood plasma fluid sampling chamber 250 while the testing device 210 is rotated.

The fluid passageway 320 extends from the blood plasma fluid sampling chamber 250 to the mixing chamber 270.

The fluid passageway 320 includes a passageway portion 320b in the form of an inverted U shape having a turnup portion disposed inwardly of the blood plasma fluid sampling chamber 250 toward the rotation center of the testing device 210. The width (cross-sectional area) of the fluid passageway 320 is small enough to allow a capillary action to take place. Further, the width and shape of the fluid passageway 320 is designed in such a manner that the fluid flowed from the blood plasma fluid sampling chamber 250 to the mixing chamber 270 is substantially equal in total amount to the fluid flowed from the synchronizing chamber 240 to the blood plasma fluid sampling chamber 250 while the testing device 210 is rotated.

The blood plasma fluid sampling chamber 250 is held in fluid communication with the first end of the fluid passageway 320 at a boundary point denoted by a reference numeral 321 spaced apart at a predetermined distance from the rotation center of the testing device 210 so that all of the fluid remained in the blood plasma fluid sampling chamber 250 is flowed out of the blood plasma fluid sampling chamber 250 through the fluid passageway 320 by the centrifugal force and siphon effect while the testing device 210 is rotated.

The method of mixing and diluting a hemolyzed blood fluid, viz., hemoglobins with a diluting fluid carried out by the present example of the testing device 210 according to the present invention will be described hereinlater.

In the present example, as the specimen was used a whole blood specimen (to be used for whole blood test), and as the diluting fluid was used a 1% SDS solution.

10 μl of the whole blood specimen was firstly introduced into the blood separating chamber 220 through the inlet port 220a. The whole blood specimen can be introduced into the blood separating chamber 220 with ease because of the fact that the blood separating chamber 220 has formed therein the air opening 220b. The whole blood specimen permeated through the fluid passageway 280 by a capillary action and then came to a stationary state at a point denoted by a reference numeral 282 stopped short of the capillary valve 280a. Likewise, 80 μl of the 1% SDS solution was introduced into the diluting fluid inlet chamber 230 through the inlet port 230a. The 1% SDS solution can be introduced into the diluting fluid inlet chamber 230 with ease because of the fact that the diluting fluid inlet chamber 230 has formed therein the air opening 230b. The 1% SDS solution permeated through the fluid passageway 290 by a capillary action and came to a stationary state at a point denoted by a reference number 292 stopped short of the capillary valve 290a.

The testing device 210 was then mounted on the turntable 713 of the rotating device 700 shown in FIG. 6. The control unit 715 was operated to control the spindle motor 714 to have spindle motor 714 rotate the testing device 210 together with the turntable 713. The testing device 210 was thus rotated by the rotating device 700 at 4000 rpm for four minutes.

During the first rotation of the testing device 210, the whole blood specimen contained in the testing device 210 was held in the blood separating chamber 220 and the fluid passageway 280 by a centrifugal force to such an extent that a surface of the whole blood specimen contained in the blood separating chamber 220 and that of the whole blood specimen contained in the fluid passageway 280 were aligned with a dotted line denoted by a reference numeral 283 as clearly shown in FIG. 13. This means that the whole blood specimen was flowed through the fluid passageway 280 beyond the capillary valve 280a toward the blood plasma fluid sampling chamber 250 and came to the line 283 stopped short of the inverted U-shaped passageway portion 280b. As will be clearly seen from FIG. 13, the dotted line 283 is illustrated as a straight line for the purpose of simplifying the description and assisting in understanding about the whole operation of the testing device 210. In reality, the surface of the whole blood specimen contained in the blood separating chamber 220 and that of the whole blood specimen contained in the fluid passageway 280 are disposed in concentric relationship with the rotation center of the testing device 210. Therefore, the dotted line 283 is a circular arc disposed in concentric relationship with the rotation center of the testing device 210. In addition, during the first rotation of the testing device 210, the whole blood specimen contained in the blood separating chamber 220 was partially hemolyzed with the potassium chloride 221 accommodated in the blood separating chamber 220 and separated into blood cells and blood plasma.

Further, during the first rotation of the testing device 210, the 1% SDS solution contained in the testing device 210 was held in the diluting fluid inlet chamber 230 and the fluid passageway 290 by a centrifugal force to such an extent that a surface of the 1% SDS solution contained in the diluting fluid inlet chamber 230 and that of the 1% SDS solution contained in the fluid passageway 290 were aligned with a dotted line denoted by a reference numeral 293 as clearly shown in FIG. 13. This means that the 1% SDS solution was flowed through the fluid passageway 290 beyond the capillary valve 290a toward the synchronizing chamber 240 and came to the line 293 stopped short of the inverted U-shaped passageway portion 290b. As will be clearly seen from FIG. 13, the dotted line 293 is illustrated as a straight line for the purpose of simplifying the description and assisting in understanding about the whole operation of the testing device 110. In reality, the surface of the 1% SDS solution contained in the diluting fluid inlet chamber 230 and that of the 1% SDS solution contained in the fluid passageway 290 are disposed in concentric relationship with the rotation center of the testing device 210. Therefore, the dotted line 293 is a circular arc disposed in concentric relationship with the rotation center of the testing device 210.

The control unit 715 was then operated to control the spindle motor 714 to have spindle motor 714 stop from rotating the testing device 210 together with the turntable 713. The testing device 210 was thus stopped from being rotated.

After the testing device 210 was stopped from being rotated, the blood plasma of the partially hemolyzed blood, hereinlater simply referred to as “partially hemolyzed blood plasma fluid”, was further flowed through the fluid passageway 280 beyond the inverted U-shaped passageway portion 280b and came to a boundary point denoted by 284 between the fluid passageway 280 and the blood plasma fluid sampling chamber 250 by a capillary action. The partially hemolyzed blood plasma fluid can be flowed through the fluid passageway 280 with ease by the capillary action because of the fact that the blood plasma fluid sampling chamber 250 has formed therein the air opening 250a. Likewise, after the testing device 210 was stopped from being rotated, the 1% SDS solution was further flowed through the fluid passageway 290 beyond the inverted U-shaped passageway portion 290b and came to a boundary point denoted by 294 between the fluid passageway 290 and the synchronizing chamber 240 by a capillary action. The 1% SDS solution can be flowed through the fluid passageway 290 with ease by the capillary action because of the fact that the synchronizing chamber 240 has formed therein the air opening 240a.

The testing device 210 was again rotated by the rotating device 700 at 1500 rpm (rotation per minute) for one minute.

During the second rotation of the testing device 210, the partially hemolyzed blood plasma contained in the testing device 210 was flowed from the blood separating chamber 220 through the fluid passageway 280 into the blood plasma fluid sampling chamber 250 by the centrifugal force and siphon effect.

As described hereinearlier, the blood separating chamber 220 is held in fluid communication with the first end of the fluid passageway 280 at the boundary point 281 spaced apart at the predetermined distance from the rotation center of the testing device 210 so that the fluid contained in the blood separating chamber 220 is flowed through the fluid passageway 280 out of the blood separating chamber 220 to have 7 μl of the fluid remained in the blood separating chamber 220 while the testing device 210 is rotated. The fact that 10 μl of the whole blood specimen had been introduced into the blood separating chamber 220 leads to the fact that approximately 3 μl of the partially hemolyzed blood plasma was introduced into the blood plasma fluid sampling chamber 250.

As described hereinearlier, the blood plasma fluid sampling chamber 250 is held in fluid communication with the first end of the fluid passageway 310 at the boundary point 311 spaced apart at the predetermined distance from the rotation center of the testing device 210 so that the fluid contained in the blood plasma fluid sampling chamber 250 is flowed out of the blood plasma fluid sampling chamber 250 through the fluid passageway 310 by the centrifugal force and siphon effect to have 1 μl of the fluid remained in the blood plasma fluid sampling chamber 250 while the testing device 210 is rotated. The fact that 3 μl of the partially hemolyzed blood plasma fluid had been introduced into the blood plasma fluid sampling chamber 250 leads to the fact that approximately 2 μl of the partially hemolyzed blood plasma fluid was flowed out of the blood plasma fluid sampling chamber 250 through the fluid passageway 310, and approximately 1 μl of the partially hemolyzed blood plasma fluid remained in the blood plasma fluid sampling chamber 250. The partially hemolyzed blood plasma fluid remained in the hemolyzed blood plasma fluid sampling chamber 250 was held in the hemolyzed blood plasma fluid sampling chamber 250 and the fluid passageway 320 by a centrifugal force to such an extent that a surface of the partially hemolyzed blood plasma fluid contained in the hemolyzed blood plasma fluid sampling chamber 250 and that of the partially hemolyzed blood plasma fluid contained in the fluid passageway 320 were aligned with a dotted line denoted by a reference numeral 323 as clearly shown in FIG. 13. This means that the partially hemolyzed blood plasma fluid flowed through the fluid passageway 320 and came to a stationary state at the line 323 stopped short of the inverted U-shaped passageway portion 320b.

Further, during the second rotation of the testing device 210, the 1% SDS solution contained in the testing device 210 was flowed from the diluting fluid inlet chamber 230 through the fluid passageway 290 into the synchronizing chamber 240 by the centrifugal force and siphon effect. As described hereinearlier, the diluting fluid inlet chamber 230 is held in fluid communication with the first end of the fluid passageway 290 at the boundary point 291 spaced apart at the predetermined distance from the rotation center of the testing device 210 so that all of the diluting fluid contained in the diluting fluid inlet chamber 230 is flowed through the fluid passageway 290 out of the diluting fluid inlet chamber 230 while the testing device 210 is rotated. The fact that 80 μl of the 1% SDS solution had been introduced into the diluting fluid inlet chamber 230 leads to the fact that approximately 80 μl of the 1% SDS solution was introduced into the synchronizing chamber 240 through the fluid passageway 290. The 1% SDS solution introduced into the synchronizing chamber 240 through the fluid passageway 290 from the diluting fluid inlet chamber 230 was held in the synchronizing chamber 240 and the fluid passageway 300 by a centrifugal force to such an extent that a surface of the 1% SDS solution contained in the synchronizing chamber 240 and that of the 1% SDS solution contained in the fluid passageway 300 were aligned with a dotted line denoted by a reference numeral 303 as clearly shown in FIG. 13. This means that the 1% SDS solution was flowed through the fluid passageway 300 toward the blood plasma fluid sampling chamber 250 and came to the line 303 stopped short of the inverted U-shaped passageway portion 300b.

The control unit 715 was then operated to control the spindle motor 714 to have spindle motor 714 stop from rotating the testing device 210 together with the turntable 713. The testing device 210 was thus stopped from being rotated for the second time. The partially hemolyzed blood plasma fluid contained in the fluid passageway 320 was flowed through the inverted U-shaped passageway portion 320b and came to a boundary point denoted by 324 between the fluid passageway 320 and the mixing chamber 270 by a capillary action. Likewise, the 1% SDS solution contained in the fluid passageway 300 was flowed through the inverted U-shaped passageway portion 300b and came to a boundary point denoted by 304 between the fluid passageway 300 and the blood plasma fluid sampling chamber 250 by a capillary action.

The control unit 715 was again operated to control the spindle motor 714 to have spindle motor 714 rotate the testing device 210 together with the turntable 713. The testing device 210 was thus rotated by the rotating device 700 at 1500 rpm (rotation per minute) for one minute.

During the third rotation of the testing device 210, the fluid contained in the blood plasma fluid sampling chamber 250 was flowed from the blood plasma fluid sampling chamber 250 through the fluid passageway 320 into the mixing chamber 270 by the centrifugal force and siphon effect. At the same time, the fluid contained in the testing device 210 is flowed from the synchronizing chamber 240 through the fluid passageway 300 into the blood plasma fluid sampling chamber 250 by the centrifugal force and siphon effect.

The width and shape of the fluid passageway 320 is designed in such a manner that the fluid flowed from the blood plasma fluid sampling chamber 250 to the mixing chamber 270 is substantially equal in amount to the fluid flowed from the synchronizing chamber 240 to the blood plasma fluid sampling chamber 250 while the testing device 210 is rotated, as described hereinearlier. In the present example, the blood plasma fluid sampling chamber 250 is made smaller in capacity than the synchronizing chamber 240 in order that the partially hemolyzed blood plasma contained in the blood plasma fluid sampling chamber 250 is flowed out by the fluid flowed from the synchronizing chamber 240.

Further, the synchronizing chamber 240 is held in fluid communication with the first end of the fluid passageway 300 at the boundary point 301 spaced apart at a predetermined distance from the rotation center of the testing device 210 so that all of the fluid contained in the synchronizing chamber 240 is flowed out of the synchronizing chamber 240 through the fluid passageway 300 by the centrifugal force and siphon effect while the testing device 210 is rotated, and the blood plasma fluid sampling chamber 250 is held in fluid communication with the first end of the fluid passageway 320 at the boundary point 321 spaced apart at a predetermined distance from the rotation center of the testing device 210 so that all of the fluid remained in the blood plasma fluid sampling chamber 250 is flowed out of the blood plasma fluid sampling chamber 250 through the fluid passageway 320 by the centrifugal force and siphon effect while the testing device 210 is rotated. This leads to the fact that approximately 1 μl of the partially hemolyzed blood plasma fluid contained in the blood plasma fluid sampling chamber 250 and the fluid passageway 320 after the testing device 210 was stopped from the second rotation and approximately 80 μl of the 1% SDS solution contained in the synchronizing chamber 240 and the fluid passageway 300 after the testing device 210 was stopped from the second rotation were all flowed through the fluid passageway 320 into mixing chamber 270.

The control unit 715 was then operated to control the spindle motor 714 to have spindle motor 714 stop from rotating the testing device 210 together with the turntable 713. The testing device 210 was thus stopped from being rotated for the third time. The partially hemolyzed blood plasma fluid and the 1% SDS solution were thus mixed with each other in the mixing chamber 270 and a diluted fluid was obtained.

The adhesive tape 271 was removed from the outlet port 270b forming part of the mixing chamber 270, and a required amount of the diluted fluid was collected by, for example, a glass tube and a pipette from the mixing chamber 270 through the outlet port 270b.

In the mixing chamber 270, approximately 111 of the partially hemolyzed blood plasma was mixed and diluted with approximately 80 μl of the 1% SDS solution at a dilution ratio of 81. In the present example, 1.6% of the partially hemolyzed blood fluid had been introduced into the blood separating chamber 220. This means that the hemolyzed blood fluid had already been diluted at a dilution ratio of 62.5. This leads to the fact that the present example of the testing device 210 makes it possible for the hemoglobins contained in the blood specimen to be diluted at a dilution ratio of approximately 5000.

From the foregoing description, it is to be understood that the present example of the testing device 210 can, with ease, carry out preprocesses such as, for example, a blood separating process, a hemolyzing process, and a diluting process within the present example of the testing device 210 while the present example of the testing device 210 is rotated and stopped from being rotated under predetermined conditions, resulting from the fact that the present example of the testing device 210 has accommodated therein a blood specimen and a diluting fluid. This leads to the fact that the present example of the testing device 210 is excellent in operability and does not cause any waste. In addition, the fact that the present example of the testing device 210 does not cause any waste leads to the fact that the present example of the testing device 210 is friendly to users and the environment.

Further, in order to dilute, for example, 111 of a blood specimen at a dilution ratio of, for example, 5000 in the conventional diluting method, 5 ml of a diluting fluid is required, thereby making it impossible for the conventional small-type testing device to dilute even a minute amount of the blood specimen with a single process. On the contrary, the present example of the testing device 210 can dilute a blood specimen at a dilution ratio of 5000 with a quite small amount, viz., 80 μl of a diluting fluid, thereby making it possible for the present example of the testing device 210 to dilute the blood specimen with a single process. This leads to the fact that the present example of the testing device 210 is excellent in operability and can be made small in size, as well as cause no waste.

In addition, the present example of the testing device 210 has a volume capable of having introduced therein equal to or more than 80 μl of the diluting fluid, which is large enough in amount to dilute the required amount of the blood specimen accommodated therein, thereby making it possible for the present example of the testing device 210 to prevent the diluting fluid from overflowing therefrom.

Further, the present example of the testing device 210 has accommodated therein potassium chloride 221 of 800 μg, which is not enough in amount to hemolyze the whole mount, viz., 10 μl of the blood specimen accommodated in the blood separating chamber 220. This means that the present example of the testing device 210 has accommodated therein potassium chloride 221 small enough in amount to partially hemolyze the blood specimen accommodated in the blood separating chamber 220, thereby reducing the amount of the diluting fluid required to be introduced therein.

Yet further, the present example of the testing device 210 has accommodated therein potassium chloride 221 of 800 μg, which is small enough in amount to partially hemolyze the blood specimen accommodated in the blood separating chamber 220 to such an extent that the hemoglobin concentration in the mixed and diluted blood plasma fluid contained in the mixing chamber 270 is diluted at a dilution ratio of equal to or more than 5000. This leads to the fact that the present example of the testing device 210 makes it possible for the mixed and diluted fluid obtained from the mixing chamber 270 to be quantified directly by, for example, a colorimetric method, a competitive immunoassay method, and/or an immunoassay method. In the case of HbAlc, measurement can be carried out based on boronic acid affinity principle, enzyme reaction principle, or the like.

Yet further, the present example of the testing device 210 comprises a blood plasma fluid sampling chamber 250 for receiving a predetermined amount, viz., 1 μl of the partially hemolyzed blood plasma fluid flowed out of the blood separating chamber 220, thereby making it possible to carry out a preprocess of measuring hemoglobins only while the testing device 210 is controlled to be rotated and stopped from being rotated.

Yet further, the present example of the testing device 210 has a plurality of openings formed with fluid passageways and chambers. This leads to the fact that the present example of the testing device 210 enables the fluids to smoothly flow through the fluid passageways and the chambers, thereby making it easier for the fluids to flow between the chambers.

The present example of the testing device 210 comprises a fluid passageway 280 having a passageway portion 280b in the form of an inverted U shape having a turnup portion disposed inwardly of the blood separating chamber 220 toward the rotation center of the testing device 210 to have a partially hemolyzed blood fluid flowed through the fluid passageway 280 by a capillary action. This leads to the fact that the present example of the testing device 210 can have the partially hemolyzed blood fluid held in the blood separating chamber 220 while the testing device 210 itself is being rotated. On the other hand, the present example of the testing device 210 can have the partially hemolyzed blood fluid flowed through the fluid passageway 280 from the blood separating chamber 220 when the testing device 210 is stopped from being rotated and the partially hemolyzed blood fluid is released from the centrifugal force.

The present example of the testing device 210 further comprises a fluid passageway 290 having a passageway portion 290b in the form of an inverted U shape having a turnup portion disposed inwardly of the diluting fluid inlet chamber 230 toward the rotation center of the testing device 210 to have a diluting fluid flowed through the fluid passageway 290 by a capillary action. This leads to the fact that the present example of the testing device 210 can have the diluting fluid held in the diluting fluid inlet chamber 230 while the testing device 210 itself is being rotated. On the other hand, the present example of the testing device 210 can have the diluting fluid flowed through the fluid passageway 290 from the diluting fluid inlet chamber 230 when the testing device 210 is stopped from being rotated and the diluting fluid is released from the centrifugal force.

The present example of the testing device 210 further comprises a fluid passageway 300 having a passageway portion 300b in the form of an inverted U shape having a turnup portion disposed inwardly of the synchronizing chamber 240 toward the rotation center of the testing device 210 to have a diluting fluid flowed through the fluid passageway 300 by a capillary action. This leads to the fact that the present example of the testing device 210 can have the diluting fluid held in the synchronizing chamber 240 while the testing device 210 itself is being rotated. On the other hand, the present example of the testing device 210 can have the diluting fluid flowed through the fluid passageway 300 from the synchronizing chamber 240 when the testing device 210 is stopped from being rotated and the diluting fluid is released from the centrifugal force.

The present example of the testing device 210 further comprises a fluid passageway 320 having a passageway portion 320b in the form of an inverted U shape having a turnup portion disposed inwardly of the blood plasma fluid sampling chamber 250 toward the rotation center of the testing device 210 to have a diluting fluid flowed through the fluid passageway 320 by a capillary action. This leads to the fact that the present example of the testing device 210 can have the diluting fluid held in the blood plasma fluid sampling chamber 250 while the testing device 210 itself is being rotated. On the other hand, the present example of the testing device 210 can have the diluting fluid flowed through the fluid passageway 320 from the blood plasma fluid sampling chamber 250 when the testing device 210 is stopped from being rotated and the diluting fluid is released from the centrifugal force.

### Eighth Example

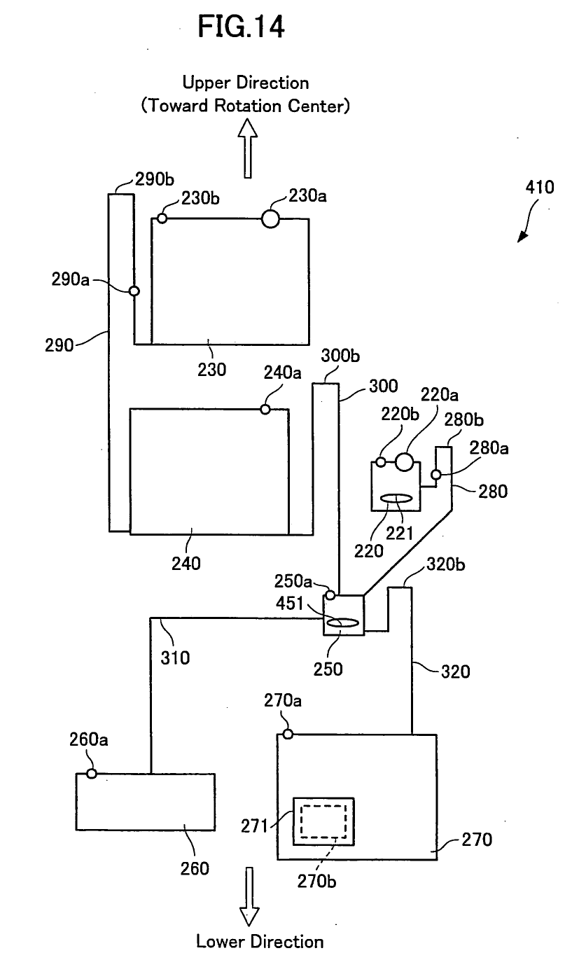

Referring now to FIG. 14 of the drawings, there is shown an eighth example of a testing device according to the present invention. FIG. 14 is a schematic top elevational view of the present example of the testing device according to the present invention. The constitutional elements of the present example of the testing device as shown in FIG. 14 is substantially the same as those of the seventh example of the testing device 210 as shown in FIG. 13 except for the constitutional elements appearing in the following description. Therefore, only the constitutional elements of the present example of the testing device different from those of the seventh example of the testing device will be described hereinafter. The constitutional elements of the present example of the testing device substantially the same as those of the seventh example of the testing device will not be described but bear the same reference numerals and legends as those of the seventh example of the testing device shown in FIG. 13 to avoid tedious repetition.

The construction of the present example of the testing device will be firstly described with reference to FIG. 14.

The present example of the testing device denoted by a reference numeral 410 is designed to dilute hemoglobins contained in erythrocytes forming part of the blood specimen at approximately 5000.

The present example of the testing device 410 is substantially the same as the seventh example of the testing device 210 except for the fact that the blood plasma fluid sampling chamber 250 has accommodated therein potassium ferricyanide 451 in advance. The potassium ferricyanide 451 serves as a denaturing agent for denaturing proteins in the partially hemolyzed blood plasma fluid.

The method of mixing and diluting a hemolyzed blood fluid, viz., hemoglobins with a diluting fluid carried out by the present example of the testing device 410 according to the present invention is substantially the same as that carried out by the seventh example of the testing device 210 according to the present invention except for the steps appearing in the following description.

80 μl of 0.1% SDS solution was introduced into the diluting fluid inlet chamber 230 through the inlet port 230a, in place of 80 μl of the 1% SDS solution. The 0.1% SDS solution does not affect an immune reaction because of the fact that the concentration of the solution is low. The 0.1% SDS solution also serves as an agent for denaturing and oxidizing hemoglobin to make the hemoglobin stabilized in terms of its absorption characteristics.

During the second rotation, the testing device 410 was rotated for equal to or more than three minutes to have the partially hemolyzed blood plasma fluid mixed with the potassium ferricyanide 451 in the blood plasma fluid sampling chamber 250 to such an extent that the partially hemolyzed blood plasma fluid was completely denatured in the blood plasma fluid sampling chamber 250.

In the mixing chamber 270, approximately 1 μl of the partially hemolyzed blood plasma was mixed and diluted with approximately 80 μl of the 0.1% SDS solution at a dilution ratio of 81. In the present example, 1.6% of the partially hemolyzed blood fluid had been introduced into the blood separating chamber 220. This means that the hemolyzed blood fluid had already been diluted at a dilution ratio of 62.5. This leads to the fact that the present example of the testing device 410 can dilute the hemoglobins contained in the blood specimen at a dilution ratio of approximately 5000. Further, the partially hemolyzed blood plasma fluid had been denatured using the potassium ferricyanide 451 in the blood plasma fluid sampling chamber 250. This leads to the fact that the present example of the testing device 410 makes it possible for an operator to collect the partially hemolyzed blood plasma fluid, which is completely denatured. Accordingly, it is preferable that the present example of the testing device 410 is used for measuring HbAlc in accordance with an immunological reactivity principle.

From the foregoing description, it is to be understood that the present example of the testing device 410 can, with ease, carry out preprocesses such as, for example, a blood separating process, a hemolyzing process, and a diluting process within the present example of the testing device 410 while the present example of the testing device 410 is rotated and stopped from being rotated under predetermined conditions, resulting from the fact that the present example of the testing device 410 has accommodated therein a blood specimen and a diluting fluid. This leads to the fact that the present example of the testing device 410 is excellent in operability and does not cause any waste. In addition, the fact that the present example of the testing device 410 does not cause any waste leads to the fact that the present example of the testing device 410 is friendly to users and the environment.

Further, the present example of the testing device 410 makes it possible for hemoglobins contained in the blood specimen to be measured by an immunological method, resulting from the fact that the present example of the testing device 410 comprises a blood plasma fluid sampling chamber 250 having accommodated therein potassium ferricyanide 451 for denaturing proteins contained in the partially hemolyzed blood plasma fluid. In addition, the same effect can still be obtained even when the blood plasma fluid sampling chamber 250 has accommodated therein, in advance, an enzyme for breaking up proteins contained in the partially hemolyzed blood plasma fluid in place of the potassium ferricyanide 451.

While it has been described in the previous examples that the testing device according to the present invention comprises a blood separating chamber having accommodated therein a hemolyzing agent for hemolyzing components forming part of the blood specimen, and an amount of the hemolyzing agent accommodated in the blood separating chamber falls short of hemolyzing all of the blood specimen accommodated in the blood separating chamber to have the blood specimen partially hemolyzed, lessen an amount of hemolyzed blood fluid to be made, and thus reduce the amount of the diluting fluid required to be introduced therein, according to the present invention, the testing device may partially hemolyze the blood specimen for a plurality of times. Partially hemolyzing a blood specimen for a plurality of times will be hereinlater referred to as “multistage partial hemolysis”. The multistage partial hemolysis makes it possible for the testing device to obtain a required amount of hemolyzed blood fluid with a greatly reduced amount of hemolyzing agent. The present example of the testing device according to the present invention may further comprise one or more additional chambers each having accommodated therein said hemolyzing agent, and an amount of said hemolyzing agent accommodated in each of said one or more hemolyzed blood chambers falls short of hemolyzing all of said blood specimen accommodated in said one or more hemolyzed blood chambers. The testing device thus constructed can partially hemolyze the blood specimen for a plurality of times, and thus further lessen an amount of hemolyzed blood fluid to be made, thereby reducing the amount of the hemolyzing agent as well as that of the diluting fluid required to be introduced therein.

### INDUSTRIAL APPLICABILITY OF THE PRESENT INVENTION

As will be seen from the foregoing description, it is to be understood that the testing device has advantages of being excellent in operability and small in comparison with the conventional testing device, as well as causing no waste. The testing device and the blood mixing and diluting method according to the present invention are available for the POCT in the field of clinical examination.

What is claimed is:

1. A testing device, comprising therein:
specimen inlet means for introducing a test specimen thereinto;
a plurality of chambers each held in fluid communication with an air opening; and
a plurality of fluid passageways respectively extending from and held in fluid communication with said chambers, said fluid passageways including at least two fluid passageways in part merged with each other to collectively define a passageway merging area, and in which
said at least two fluid passageways include one or more diluting fluid passageways each having a diluting fluid flowed therethrough and a specimen fluid passageway held in fluid communication with said specimen inlet means to have said test specimen flowed therethrough into said passageway merging area, in such a manner that said test specimen is held in said passageway merging area to be mixed and diluted with said diluting fluid at a predetermined dilution ratio.

2. A testing device as set forth in claim 1, in which
said chambers include a blood separating chamber held in fluid communication with said specimen inlet means through an inflow fluid passageway forming part of said specimen fluid passageway to receive a blood specimen, and a hemolyzed blood chamber having accommodated therein a hemolyzed blood fluid,
said testing device is operative to be rotated around a rotation center and stop from being rotated to have said blood specimen accommodated in said blood separating chamber separated into blood cells and a blood plasma fluid, and
said blood separating chamber is held in fluid communication with said passageway merging area through an outflow fluid passageway forming part of said specimen fluid passageway to have said blood plasma fluid separated from said blood specimen flowed through said outflow fluid passageway, in such a manner that said hemolyzed blood fluid is mixed and diluted with said blood plasma fluid in said passageway merging area.

3. A testing device as set forth in claim 2, in which
said passageway merging area is formed with an air opening to have said blood plasma fluid and said hemolyzed blood fluid flowed thereinto and mixed with each other.

4. A testing device as set forth in claim 2, in which
said outflow fluid passageway of said specimen fluid passageway extending from said blood separating chamber to said passageway merging area includes an upper fluid passageway portion disposed inwardly of said blood separating chamber toward said rotation center and a lower fluid passageway portion disposed outwardly of said blood separating chamber from said rotation center.

5. A testing device as set forth in claim 2, in which
said blood separating chamber has accommodated therein a hemolyzing agent for hemolyzing said blood specimen.

6. A testing device as set forth in claim 2, in which
said blood separating chamber has accommodated therein a denaturing agent for denaturing hemoglobins contained in hemolyzed blood.

7. A testing device as set forth in claim 2, in which
said blood separating chamber has accommodated therein a proteolytic enzyme for breaking up hemoglobins contained in hemolyzed blood.

8. A testing device as set forth in claim 2, in which
said chambers include two or more chambers held in fluid communication with one another through one or more of said fluid passageways each disposed inwardly of said chamber held in fluid communication with said specimen inlet means toward said rotation center, and
one of said two or more chambers is held in fluid communication with said specimen inlet means to have said blood specimen flowed from said specimen inlet means thereinto and then into the other remaining ones of said two or more chambers through said one or more of said fluid passageways.

9. A testing device as set forth in claim 1, in which
said specimen inlet means is operative to introduce therein a blood specimen, and
said fluid passageways includes a hemolyzing process fluid passageway held in fluid communication with said specimen inlet means to have said blood specimen introduced from said specimen inlet means and hemolyzed therein.

10. A testing device as set froth in claim 9, in which
said hemolyzing process fluid passageway includes:
a hemolyzing process fluid passageway portion capable of having said blood specimen introduced from said specimen inlet means and temporarily held therein to have said blood specimen hemolyzed to produce a hemolyzed blood fluid, and
fluid stopping means for stopping a fluid from being flowed into said hemolyzing process fluid passageway portion by a capillary action.

11. A testing device as set forth in claim 10, in which
said hemolyzing process fluid passageway portion is merged with the other one or more fluid passageways to collectively define a passageway merging area to have said hemolyzed blood fluid flowed from said hemolyzing process fluid passageway portion into said passageway merging area.

12. A testing device as set forth in claim 11, in which
said chambers includes a blood processing chamber intervening between and held in fluid communication with said specimen inlet means and said hemolyzing process fluid passageway,
said hemolyzing process fluid passageway further includes:
closing means disposed between said blood processing chamber and said hemolyzing process fluid passageway portion, for closing said hemolyzing process fluid passageway to have any fluid prevented from being flowed between said hemolyzing process fluid passageway portion and said blood processing chamber.

13. A testing device as set forth in claim 12, in which
said hemolyzing process fluid passageway further includes:
fluid stopping means disposed between said hemolyzing process fluid passageway portion and said passageway merging area to stop a fluid from being flowed from said hemolyzing process fluid passageway portion into said passageway merging by a capillary action.

14. A testing device as set forth in claim 13, in which
said blood specimen is hemolyzed while said testing device is being rotated,
said hemolyzing process fluid passageway further includes an outflow fluid passageway portion extending from said hemolyzing process fluid passageway portion to said passageway merging area, and
said outflow fluid passageway portion includes an upper outflow fluid passageway portion disposed inwardly of said blood processing chamber toward said rotation center and a lower outflow fluid passageway portion disposed outwardly of said blood processing chamber from said rotation center.

15. A testing device as set forth in claim 12, in which
said closing means is operative to cause a chemical change between said blood processing chamber and said hemolyzing process fluid passageway portion to close said hemolyzing process fluid passageway to have any fluid prevented from being flowed between said hemolyzing process fluid passageway portion and said blood processing chamber.

16. A testing device as set forth in claim 1, in which
said one or more diluting fluid passageways have said diluting fluid flowed through said passageway merging area toward a predetermined direction, and
said specimen fluid passageway is capable of having said test specimen temporarily held in said passageway merging area, to have said test specimen mixed and diluted with said diluting fluid at a predetermined ratio.

17. A testing device as set forth in claim 16, in which
said specimen fluid passageway and each of said one or more diluting fluid passageways are intersected by and held in fluid communication with each other at said passageway merging area through a space greater in width than the other neighboring portion of each of said specimen fluid passageway and said one or more diluting fluid passageways.

18. A testing device as set forth in claim 17, in which
each of said specimen fluid passageway and said one or more diluting fluid passageways has an end portion held in fluid communication with an air opening.

19. A testing device as set forth in claim 17, in which
said plurality of fluid passageways include an extension fluid passageway having an end portion held in fluid communication with said specimen fluid passageway at said passageway merging area through a space greater in width than the other neighboring portion of said specimen fluid passageway and said extension fluid passageway.

20. A testing device as set forth in claim 16, in which
said fluid passageways include a fluid passageway having a turnup portion disposed outwardly of said passageway merging area from said rotation center to have said fluid specimen accommodated therein in said turnup portion.

21. A blood mixing and diluting method, comprising:
an introducing step of introducing a blood specimen into a testing device;
a dividing step of dividing said blood specimen introduced into said testing device in said introducing step into a first blood portion to be hemolyzed and a second blood portion to be separated into a blood plasma and blood cells;
a blood cell and blood plasma obtaining step of rotating said testing device to have said first blood portion hemolyzed and said second blood portion separated into blood cells and a blood plasma;
a fluid flowing step of stopping said testing device from rotating to have a fluid of said hemolyzed blood, i.e., a hemolyzed blood fluid and said blood plasma flowed through respective fluid passageways; and
a mixing and diluting step of rotating said testing device to have said hemolyzed blood fluid mixed and diluted with said blood plasma.

22. A testing device as set forth in claim 1, in which
said chambers include a blood separating chamber held in fluid communication with said specimen inlet means to receive a blood specimen to have therein said blood specimen hemolyzed and separated into a blood plasma and blood cells while said testing device is rotated, a diluting fluid introducing chamber for introducing thereinto a diluting fluid for diluting components forming part of said blood specimen, and a mixing chamber for receiving said blood plasma and said diluting fluid to have said blood plasma mixed with and diluted with said diluting fluid while said testing device is rotated, and
said blood separating chamber has accommodated therein a hemolyzing agent for hemolyzing components forming part of said blood specimen.

23. A testing device as set forth in claim 22, in which
a total capacity of said testing device is capable of having introduced therein equal to or greater than an amount of said diluting fluid required to dilute all of said components forming part of said blood specimen.

24. A testing device as set forth in claim 22, in which
an amount of said hemolyzing agent accommodated in said blood separating chamber falls short of hemolyzing all of said blood specimen accommodated in said blood separating chamber.

25. A testing device as set forth in claim 24, in which
an amount of said hemolyzing agent accommodated in said blood separating chamber is substantially small enough to have said components forming part of said blood plasma partially hemolyzed to such an extent that said components forming part of said blood plasma partially hemolyzed are mixed and diluted with said diluting fluid in said mixing chamber at a dilution ratio of 250 or greater.

26. A testing device as set forth in claim 24, in which
an amount of said hemolyzing agent accommodated in said blood separating chamber is substantially small enough to have said components forming part of said blood plasma partially hemolyzed to such an extent that said components forming part of said blood plasma partially hemolyzed are mixed and diluted with said diluting fluid in said mixing chamber at a dilution ratio of 500 or greater.

27. A testing device as set forth in claim 24, in which
an amount of said hemolyzing agent accommodated in said blood separating chamber is substantially small enough to have said components forming part of said blood plasma partially hemolyzed to such an extent that said components forming part of said blood plasma partially hemolyzed are mixed and diluted with said diluting fluid in said mixing chamber at a dilution ratio of 5000 or greater.

28. A testing device as set forth in claim 22, in which
said chambers further include:
a blood plasma fluid sampling chamber for taking thereinto a predetermined amount of a blood plasma fluid flowed from said blood separating chamber to be mixed with said diluting fluid in said mixing chamber.

29. A testing device as set forth in claim 28, further comprises
a denaturing agent for denaturing proteins forming part of said blood plasma fluid in a predetermined area to have said denaturing agent reacted with said predetermined amount of said blood plasma fluid taken into said blood plasma fluid sampling chamber.

30. A testing device as set forth in claim 28, further comprises
a proteolytic enzyme for breaking up proteins forming part of said blood plasma fluid in a predetermined area to have said proteolytic enzyme reacted with said predetermined amount of said blood plasma fluid taken into said blood plasma fluid sampling chamber.

31. A testing device as set forth in claim 22, in which
at least one of said chambers and said fluid passageways is held in fluid communication with an air opening.

32. A testing device as set forth in claim 22, in which
at least one of said fluid passageways has a turnup portion disposed inwardly of a chamber, which said at least one of said fluid passageways is held in communication with, toward said rotation center to have a fluid flowed therethrough by way of a capillary action.

33. A testing device as set forth in claim 22, in which
said chambers include one or more hemolyzed blood chambers each having accommodated therein said hemolyzing agent,
an amount of said hemolyzing agent accommodated in each of said one or more hemolyzed blood chambers falls short of hemolyzing all of said blood specimen accommodated in said one or more hemolyzed blood chambers.

34. A blood mixing and diluting method of mixing and diluting components forming part of a blood specimen using a testing device, comprising:
an introducing step of introducing a blood specimen into said testing device;
a diluting fluid introducing step of introducing a diluting fluid for diluting said components forming part of said blood specimen;
a hemolyzing and separating step of rotating said testing device to have said blood specimen hemolyzed and separated into blood cells and a blood plasma;
a fluid flowing step of stopping said testing device from rotating to have a fluid from said blood plasma and said diluting fluid flowed; and
a mixing and diluting step of rotating said testing device to have said fluid from said blood plasma mixed with said diluting fluid.
